(19) United States
(12) Patent Application Publication
(10) Pub. No.: US 2015/0316001 A1
(43) Pub. Date: Nov. 5, 2015

(54) Pulse Detonation Engine with Variable Control Piezoelectric Fuel Injector

(71) Applicant: Weidlinger Associates, Inc., Mountain View, CA (US)

(72) Inventors: Paul Reynolds, Mountain View, CA (US); Robert Andrew Banks, Mountain View, CA (US)

(73) Assignee: Weidlinger Associates, Inc., Mountain View, CA (US)

(21) Appl. No.: 14/691,255

(22) Filed: Apr. 20, 2015

Related U.S. Application Data
(63) Continuation of application No. 13/252,127, filed on Oct. 3, 2011, now abandoned.

(51) Int. Cl. F02K 7/06

(52) U.S. Cl. CPC F02K 7/06; F05D 2220/80; F05D 2270/62; F05D 2240/35

(57) ABSTRACT

A pulse detonation engine including one or more fuel injectors comprising one or more piezoelectric driving stacks wherein a flow control member of each injector is driven directly by the one or more piezoelectric stacks without additional amplification means or interposing elements while a flow area of the nozzle is variably adjustable to deliver controlled flow rates in a desired flow profile to improve engine performance and reduce emissions. The pulse detonation engine configured to support variable mission and operational requirements including delivery of required thrust using specific fuel types and with power and performance of the pulse detonation engine variably adaptable. The fuel injectors associated with the pulse detonation engine configure to deliver specified flow rates with minimal linear movement of the flow control member. The injector and drive electronics configured to deliver higher frequency operation and response with increased operational stability.

### CROSS REFERENCE TO RELATED APPLICATIONS

This application is a continuation of application Ser. No. 13/252,127, filed Oct. 3, 2011, now pending. The patent application identified above is incorporated here by reference in its entirety to provide continuity of disclosure.

### STATEMENT REGARDING FEDERALLY SPONSORED RESEARCH OR DEVELOPMENT

This invention was made with government support under U.S. Navy Contract Number N00014-08-C-0546 awarded by the Office of Naval Research. The government has certain rights in the invention.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND

1. Field of the Invention

The present invention relates to pulse detonation engines. More particularly, the present invention is related to pulse detonation engines having piezoelectrically actuated fuel injectors.

2. Related Art

Pulse detonation engines have been of interest for several decades as an alternative propulsion technology. This interest is driven in large part by the theoretical higher efficiency of pulse detonation engines compared to normal combustion engines. Pulsed detonation engines are estimated to have maximum efficiency of 49% while standard combustion engines have a maximum efficiency of 27%. Consequently, successful development of pulse detonation technology could play a significant role in the reduction of fuel consumption in many commercial and military applications. The approaches differ in that the efficiency of detonation is significantly higher than deflagration associated with normal combustion technology. Deflagration is the chemical process of burning rapidly with flames; detonation is a sudden and violent explosion, creating a shockwave that travels at supersonic speeds. The material conversion rate associated with detonation is typically tens of thousands times faster than in a flame. Additionally, the thrust produced by a pulse detonation engine does not require complex rotating machinery and hence, the mechanical design of a pulse detonation engine tends to be much simpler. An operational pulse detonation engine will significantly reduce pollutants since the extremely high operational temperatures considerably reduce the presence of unburned hydrocarbons. This thermal efficiency creates a derivative benefit of enhanced fuel economy. Despite the promise of pulse detonation technology, a critical aspect of viability hinges on the provision of an appropriate fuel injector system capable of operating at the frequencies and in the operational environments associated with pulse detonation technology.

A fuel injector is a device for actively depositing fuel into an internal combustion engine by directly forcing the fuel into a combustion chamber of the engine at an appropriate moment in the combustion cycle. For piston engines, the fuel injector is an alternative to a carburetor, in which a fuel-air mixture is drawn into the combustion chamber by downward displacement of the piston, creating a low-pressure draw.

Present-day fuel injectors suffer from an inability to operate at high frequencies. This limits their applicability to advanced and emerging engine designs. For reciprocating engines, the operational frequencies are described in revolutions per minute (RPM). The RPM for the engine is translated into an operational frequency for each injector where the injector generally operates in a binary manner of open and closed states. For pulse detonation engines, the frequency is described in terms of cycles per second, rather than in terms of rotary motion, where each cycle is a detonation cycle. The detonation cycle does not necessarily correspond to the operational cycle associated with injectors used to support the detonation cycle of the pulse detonation engine.

In addition to issues associated with high frequency operation, present-day injectors are not designed to vary the fuel delivery profile during an injection/combustion cycle. They also suffer from an intrinsic response lag associated with several factors, including actuator displacement amplification. This lag is a delay in response and exists in both the control system and in the process or system under control. Additionally, present-day piezoelectric injectors do not directly actuate the member that controls the fuel flow. For purposes described herein, “direct” actuation is defined as the direct physical interaction of the prime actuating device with the primary flow control member which, when moved by the prime actuating device, immediately causes a change in the rate of flow of fuel into the combustion chamber. “Direct actuation” is further defined herein as actuation in which there exists a one-to-one relationship between the actuating device and the flow control member with no additional interposing elements, amplification steps, flow channels, control pressures or other ancillary elements to operate the flow control member.

Now, the context for use of a fuel injector in pulse detonation technology is described. A pulse detonation engine is a propulsive system that uses detonation waves to combust a fuel and oxidizer mixture for propulsion. The engine is pulsed, meaning that the combustible mixture is renewed in the combustion chamber between each detonation wave initiated by an ignition source. Pulse detonation engines are of great interest due to their potential for higher propulsion efficiency, lower emissions, ease of manufacturing, low cost of manufacturing, potential for inclusion in compact and missile-like geometries, an anticipated ability to operate from subsonic through supersonic speeds, and, for use in power generation.

As discussed above, traditional rotary engines operate via deflagration of the fuel-air mixtures. Deflagration is the combustion of the fuel-air mixtures at subsonic velocities. Detonation, on the other hand, is the process whereby fuel burns at supersonic speeds. In a pulse detonation engine, the detonation reaction generates a coupled shockwave and combustion regime that travel together along the length of a detonation tube of the engine at velocities from 1.5 km/s to more than 2 km/s. Since fuel is burned at high speed within the combustion chamber of the pulse detonation engine, combustion occurs at a near constant volume, unlike regular engines. Hence, the thermodynamic cycle efficiency of detonation is much higher than that of deflagration. Theoretical efficiency increase of pulse detonation technology is more than double that of standard combustion. Consequently, a pulse detonation engine has the capacity to deliver a more fuel-efficient propulsive engine.

Since pulse detonation engines promise higher fuel efficiency through detonation rather than combustion of fuel, this feature translates into propulsion systems having a longer range for the equivalent fuel reserve. Alternatively, pulse detonation technology will allow a lighter, smaller system, using less fuel to travel an equivalent distance. Due to their inherent mechanical simplicity, pulse detonation engines have the potential to deliver equivalent propulsion at a much lower cost than combustion technology. Unlike a standard turbine engine where propulsion is created by combusted fuel, there are very few moving parts in a pulse detonation engine. These features cause this technology to be of great interest in tactical missile systems, where the engine is destroyed during use.

Despite the many promises, researchers and designers of pulse detonation systems have struggled with an inability to control the timing and modulation of fuel injection into the combustion chamber of the pulse detonation engine. Timing the injection so that fuel is in the engine at all locations during ignition is critical. Today, this injection control is essentially impossible to achieve using present-day fuel injector technology and associated valve arrangements. Thus, a need exists for highly responsive and controllable fuel injectors that can deliver the desired granularity of control to facilitate evolution of pulse detonation technology to operational viability.

Another challenge associated with operating a pulse detonation system is delivering differing fuel-to-air ratios at various locations in the detonation tube during each detonation cycle to maximize engine efficiency. For example, in one case, it is estimated that the best efficiency is obtained by a leaner mixture of fuel-air at the outlet end of the detonation tube, with the fuel-to-air ratio rising at the internal ignition site. Depending on the particular design of the pulse detonation engine, other air-fuel mixtures and ratios will need to be accommodated. Consequently, there is a need for highly resolute analog control of injection to facilitate fuel-to-air ratio variation.

Although critical to success of pulse detonation technology, standard diesel and jet engines will benefit from fuel injectors having the similar capabilities. Leveraging the inclusion of the injector technology described herein, pulse detonation technology will become a legitimate engine modality and source for power generation.

To understand the benefit of the inclusion of the injector technology described herein with pulse detonation technology, several considerations are described. First, present-day piezoelectric stack actuators used in fuel injectors do not provide direct actuation of the primary injector flow control member. Instead, the piezoelectric stack is typically used to simply open and close a separate valve, which triggers a separate mechanical process. This trigger valve is used to vary hydraulic pressure to assist in opening the primary valve of the nozzle assembly. This multi-step process of indirect hydraulic actuation and amplification creates an inherent limit to the upper operational frequency of present-day injectors due to intrinsic response lag. Consequently, these dual stage injectors generally will not support higher frequency operation necessary for the operation of a pulse detonation engine.

In typical fuel injector configurations, a nozzle assembly portion of the injector is located adjacent the combustion chamber of the engine. The nozzle includes a pin, considered the primary flow control member, and an orifice to control flow of fuel into the combustion chamber. When the pin seats on a sealing portion of the orifice, fuel flow is cut off. When the pin is unseated from the sealing portion of the orifice, fuel flow is enabled. The rate of fuel flow is controlled by the size of the orifice, in conjunction with the properties of the selected fuel, fuel supply delivery pressure and combustion chamber pressures throughout the combustion cycle.

As earlier indicated, hydraulic amplification is used to open and close the nozzle assembly. High-pressure fuel is delivered to the nozzle compartment. The shape of the pin results in over-balanced pressure, causing the pin to be seated on the orifice in a closed position. An upstream actuator opens a pressure relief valve associated with the fuel delivery system, reducing pressure on one side of the pin. This results in a directional net linear force and causes the pin to lift off its seat and the nozzle to open. By closing the relief valve, pressure returns to its original level and the pin, typically assisted by a spring member, reseats to close the nozzle.

When a piezoelectric stack is used in the above manner, the overall system is mechanically and operationally more complex. Amplification of the displacement of the stack is required due to the extremely limited displacement of a piezoelectric stack relative to the displacement required to lift the pin a distance off its seat to enable the flow of fuel through an orifice. This amplification typically requires more intricate flow arrangements within the body of the injector, including additional valves and additional sealing elements. Hydraulic amplification also introduces actuator response lag due to the multiple-step actuation process. This response lag impedes the ability of a hydraulically amplified injector, even those using piezoelectric actuators, from operating at higher frequencies, such as those that might be required for pulse detonation engines or racing engines.

Present injector actuation methods have other limitations. For example, most injectors operate in a binary on/off fashion. Specifically, either the valve is fully open, with flow at maximum, or fully closed, with flow equal to zero. It would be preferable to provide analog control of the entire fuel injection profile during an injection/combustion cycle. Where the injector operates in a fully-open and fully-closed state, attempts have been made to obtain such analog control by opening and closing the injector valve frequently and at differing durations during the course of an injection cycle. Unfortunately, this approach creates an even higher operational demand on the injector apparatus due to the multiplication of actuation cycles during each injection cycle.

Available displacement of the actuating means used in an injector directly drives how the actuating means might be used in the design of an injector. Two primary technologies used as “actuating” means, electromagnetic actuators and piezoelectric actuators, have substantially different available displacements, differing by several orders of magnitude. For example, electromagnetic actuators, also known as solenoids, can supply sufficient linear displacement of an injector pin to fully open a valve by lifting the pin off its seat to allow the fuel to flow through an orifice. However, as indicated, these operate in only two modes: fully open and fully closed. A solenoid valve is another type of electromechanical valve incorporating an electromagnetic solenoid actuator. In some solenoid valves, the solenoid acts directly on the main valve. Others use a separate solenoid valve, known as a pilot valve, to actuate a larger valve through which fuel will flow into a combustion chamber. A piloted valve requires less power to control and operate, but are noticeably slower. Piloted solenoids also usually require full power at all times to open and remain open, whereas a direct acting solenoid usually only requires full power for a short period to open, and low power to hold in a closed position. Irrespective of the type of solenoid used, the actuator will suffer from response lag, which is exacerbated as operational frequencies increase.

A second actuator type, using piezoelectric material to provide displacement, can provide faster response than a solenoid actuator. However, a piezoelectric actuator has miniscule displacement. Generally, a standard piezoelectric stack made of piezoceramic material provides maximum displacement of 1/10^{th} of 1% of stack height; stacks made with single crystal piezoelectric material will provide displacement up to 1% of stack height. Consequently, heretofore, this displacement limitation has forced piezoelectric actuation mechanisms in fuel injectors to be used in an amplification configuration rather than directly actuate the primary flow control member. Necessarily, by definition, prior piezoelectric injector configurations that rely on displacement amplification do not deliver direct actuation of the flow control member.

Various attempts have been made to increase or amplify the displacement of piezoelectric actuators so that they might become useful in existing engine configurations. For example, a design known generally as a flextensional actuator includes a geometrically constrained piezoelectric actuator device that amplifies displacement along an axis perpendicular to the axis of displacement by using a constrained diamond-shaped enclosure. As the piezoelectric element of the flextensional actuator contracts or expands in a horizontal direction, the external diamond-shaped enclosure also changes shape, causing the vertical vertices of the enclosure to move a slightly greater distance than the horizontal vertices, which are controlled by the piezoelectric element. Unfortunately, the inclusion of this mechanical feature introduces the limitation of a mechanical spring variable that limits high frequency operation of the actuator and reduces operational longevity. Additionally, the use of the flextensional approach to increase displacement includes a corresponding reduction in the maximum force that can be applied by the stack. Further, the flextensional configuration is capable of increasing displacement by only a small amount and would still require amplification if used as an actuator in a fuel injector.

Information relevant to other attempts to address the problems associated with the use of a piezoelectric actuator in a fuel injector can be found in U.S. Pat. Nos. 7,786,652; 7,455,244; 7,406,951; 7,140,353; 6,978,770; 6,834,812; 6,585,171; and 4,803,393. Each of these references fails to provide a solution for use of a piezoelectric actuator having minuscule displacement wherein the piezoelectric actuator directly drives the flow control member of the injector. Additionally, and in further detail, these references suffer from one or more of the following disadvantages, which impede high frequency operation and limit optimization throughout each combustion cycle to create maximum efficiency. These include: (1) indirect actuation; (2) partial spring actuation; (3) complex mechanisms with a plurality of components and parts; (4) operation only in a fully-open or fully-closed position; (5) desired displacement distances which would require prohibitively long piezoelectric stacks; (6) one or more boosters to achieve opening forces; (7) actuating mechanisms unable to accommodate sufficient displacement; (8) inclusion of spring elements likely to induce valve float at higher frequency operation; (9) indirect actuation via hydraulic amplification resulting in lag and hysteresis; (10) no analog control of valve position; (11) inability to provide refined prestress on the piezoelectric stack to avoid placing it in tension; and (12) inability to adapt in real time to changing operating parameters or engine performance requirements. Additionally, none of the references describes an injector having a one-to-one relationship between the prime actuating force and the flow control member; instead, each describes interposing elements. Consequently, these other references do not provide for direct actuation.

For example, Nakamura et al., U.S. Pat. No. 7,786,652 B2 issued Aug. 31, 2010, describes an injection apparatus using a multi-layered piezoelectric element stack. The invention disclosed by Nakamura et al. is directed to a need for a multi-layer piezoelectric element that can be operated continuously with a high electric charge without peel-off or cracking between the external electrode and the piezoelectric layer, which can lead to contact failure and device shutdown. The injector apparatus described by Nakamura et al. uses a needle valve that is sized to plug an injection hole to shut off fuel. The injector apparatus includes a spring underneath a piston valve member so that when power is removed from a piezoelectric actuator, the spring actually causes the valve to open and allow fuel injection. The stack only acts to close the valve. Furthermore, Nakamura et al. does not describe a method for prestressing the piezoelectric stack. General operation of the injector is either fully open or fully closed, with no ability to provide variable injection rates. The fuel flow rate is controlled by an orifice and is not adjustable. Additionally, it is unclear how the piezoelectric stack described by Nakamura et al. would provide sufficient displacement or contraction to move the needle sufficiently to unseat from the orifice, even with the inclusion of a supplementary spring. In particular, for the operational requirements associated with pulse detonation engines, the injector described by Nakamura et al. would neither enable sufficient flow nor operate at a sufficiently high frequency. Thus, the injector described by Nakamura does not have a one-to-one relationship between the prime actuating force and the flow control member without interposing elements. It is therefore not directly actuated.

Further, Boecking, U.S. Pat. No. 7,455,244 B2 issued Nov. 25, 2008, describes a piezoelectric fuel injector for injecting fuel into a combustion chamber of an internal combustion engine, wherein the injector includes a first and second booster piston, and the first booster piston is actuated using a piezoelectric stack to actuate the second booster piston which then moves a pin off seat to open the injection opening. The injector described by Boecking is directed to a need for a fuel injector of especially compact structure. Multiple springs within the injector body are used to generate closing forces. The system described by Boecking is a complex mechanism with insufficient displacement to move the pin sufficiently to support high volume fuel delivery. Due to the inclusion of spring-loaded elements, the described injector will suffer float at higher frequency operation. Additionally, Boecking's injector relies on the movement of a small needle valve, which will inhibit the ability to deliver flow at higher rates. Further, Boecking's injector does not have a one-to-one relationship between the prime actuating force and the flow control member without interposing elements; therefore, the injector of Boecking is not directly actuated.

Stoecklein, U.S. Pat. No. 7,406,951 issued Aug. 5, 2008, describes a piezoelectric fuel injector for injecting fuel into an internal combustion engine wherein the fuel injector has an injection valve member that is indirectly actuated by a piezoelectric actuator. Stoecklein suggests that the injection valve member is “directly” actuated by the piezoelectric stack, but the description confirms that hydraulic amplification is used between the actuator and the injection valve.

Hence, as defined herein, the injector of Stoecklein is not directly actuated. Additionally, the valve member relies on a spring element to move into a closed position. Stoecklein's invention also attempts to solve the problem in prior piezoelectric fuel injectors whereby intermediate positions of the valve between fully open and fully closed are unstable and cannot be maintained. Stoecklein describes a solution involving multistage hydraulic boosting of the actuator displacement to achieve stable intermediate stop positions. To overcome system pressure and open the valve member, an initial force is applied by reducing the current supply to the piezoelectric actuator. The shrinking length causes a pressure decrease in a hydraulic coupling chamber and, in turn, the control chamber. After a critical pressure has been reached, the valve opens to an intermediate displacement position. In order to achieve a complete opening of the valve member, the boosting is changed once the piezoelectric actuator has traveled a certain amount of its displacement distance. Stoecklein's approach does not address issues of response lag nor adaptation to operate at high frequencies. Furthermore, although limited two-stage control is described, highly granular, essentially analog control is not supported by Stoecklein's injector system. As with the prior referenced designs, the injector includes springs that can cause valve float at higher operational frequencies. Stoecklein also confirms that a displacement of several hundred micrometers would be required to deliver desired flow rates, whereas the displacement available from reasonably sized stacks is about 20 to 40 microns. Additionally, the injector of Stoecklein must rely on a two-stage boost to achieve sufficient opening. As in the other referenced designs, Stoecklein's injector does not have a one-to-one relationship between the prime actuating force and the flow control member; interposing elements are required. Hence, Stocklein's injector is not directly actuated.

Rauznitz et al., U.S. Pat. No. 7,140,353 B1 issued Nov. 28, 2006, describes a piezoelectric injector containing a nozzle valve element, a control volume, and an injection control valve for controlling fuel flow wherein a preload chamber is used to apply a preload force to the piezoelectric stack elements. Rauznitz et al. emphasizes the necessity of the hydraulic preload to prestress the piezoelectric stack to ensure reliable operation. As described, the injector of Rauznitz et al. operates only in a closed and open position. It fails to provide analog control of the valve position throughout its range of displacement. Thus, it is unable to deliver highly granular control of the flow profile throughout each combustion/detonation/injection cycle. Additionally, opening and closing of the valve necessitates amplification with actuation of multiple components. Thus, the injector of Rauznitz et al. fails to provide direct actuation of the valve control member, limiting application in high frequency injection scenarios, and, fails to provide highly granular control of the fuel flow profile, limiting use, for example, in pulse detonation engines. Finally, the injector is designed to accommodate small injector needles; it would not support large injector sizes to accommodate increased fuel flow. Thus, the injector of Rauznitz et al. does not have a one-to-one relationship between the prime actuating force and the flow control member. Interposing elements are required, resulting in an indirect actuation, not direct actuation.

Rauznitz et al., U.S. Pat. No. 6,978,770 B2 issued Dec. 27, 2005, describes a piezoelectric fuel injection system and method of control wherein the fuel injector contains a piezoelectric element, a power source for activating the element to actuate the injector, and a controller for charging the piezoelectric element directed to control of the injection rate shape. The system disclosed by Rauznitz et al. delivers closed, intermediate and fully open control. These three positions are further supported by rapid opening and closing of a nozzle valve element to create an improved rate shape. Precise control and analog positioning of the nozzle valve needle throughout its displacement is not possible. Furthermore, the injector uses springs to bias the valve element into a closed position, which introduces complexity and will cause the injector to suffer float at higher frequency operation. Thus, the injector of Rauznitz et al. does not have a one-to-one relationship between its prime actuating force and its flow control member without interposing elements; therefore, the injector of Rauznitz et al. is not directly actuated.

Neretti et al., U.S. Pat. No. 6,834,812 B2 issued Dec. 28, 2004, describes a piezoelectric fuel injector directed to providing inward displacement of the valve to avoid external soilage. The valve is contained within an injection pipe and is moveable along its axis between a closed and an open position by expansion of the piezoelectric actuator. There are only two valve positions—fully open and fully closed—without the ability for analog or variable injection. A mechanical transmission is placed between the piezoelectric actuator and the valve in order to invert the displacement produced by expansion of the piezoelectric actuator and displace the valve in an inward direction. This mechanism adds complexity to the injector. Thus, the injector of Neretti et al. does not have a one-to-one relationship between prime actuating force and the flow control member without interposing elements; therefore, the injector of Neretti et al. is not directly actuated.

Boecking, U.S. Pat. No. 6,585,171 B1 issued Jul. 1, 2003, describes a fuel injector system comprising a fuel return, high-pressure port, piezoelectric actuator stack, hydraulic amplifier, valve, nozzle needle, and injection orifice. The piezoelectric stack of the Boecking injector does not directly actuate the nozzle needle. Close examination reveals that the piezoelectric stack instead actuates a separate hydraulic amplifier to open the valve, which allows the nozzle needle to move off the injection orifice. The needle of the Boecking injector is not directly actuated by the piezoelectric stack. Furthermore, the Boecking injector is limited to operation in two discrete modes: on and off. Hence, Boecking's injector does not have a one-to-one relationship between its prime actuating force and its flow control member. Interposing elements are required and thus, the injector is not directly actuated.

Takahashi, U.S. Pat. No. 4,803,393 issued Feb. 7, 1989, describes a piezoelectric actuator for moving an object member wherein the actuator includes a piezoelectric element, an envelope having a bellows, and a pressure chamber where work oil is hermetically enclosed. The invention disclosed by Takahashi is directed to the need for an improved piezoelectric actuator that can prevent the breakdown of the piezoelectric element due to slanting attachments and defective sliding. This is achieved by an envelope between the piezoelectric element and the valve or object member, the envelope containing a resilient member and hermetically containing a fluid. The inclusion of the envelope and spring mechanisms in the injector of Takahashi introduces the problem of valve float at higher operational frequencies, along with indirect actuation limitations. Additionally, the piezoelectric actuator of Takahashi is not used to directly actuate the needle that controls flow; the actuator is used to move a separate upstream control valve that then allows flow to be delivered to the injector assembly. Hence, Takahashi's injector does not have a one-to-one relationship between a prime actuating force and the flow control member without interposing elements; therefore, the injector of Takahashi is not directly actuated.

Hence, the use of a piezoelectric stack to directly actuate the flow control member of an injector in an operational context has heretofore been unavailable. In efforts to deliver adequate injection control in the operation of a pulse detonation engine, other challenges are presented by the operational theater in which pulse detonation engines are likely to be used. For example, in certain military applications, there is little choice as to the available fuel type and quality due to location in the battle field or region of deployment. Hence, an injector used in a pulse detonation engine should adjust to accommodate available fuel type, including dirty fuel. When an injector controls the rate of fuel delivery by use of a static orifice, the fuel flow will vary considerably with fuel type due to changing fluid properties including viscosity. Where fuel is contaminated, there exists a high risk of injector orifice plugging. In particular, in an operational theater, pulse detonation engines can be required to use JP-7, JP-10, diesel, biodiesel or other combustible fuels. The fuels can also be contaminated with particulate impurities or other diluting components, such as water. Consequently, there exists a need for a pulse detonation engine having an injector that can be quickly adjusted or replaced to accommodate differing combustion properties and qualities of each fuel type.

An injector must operate at high frequencies to support the operational characteristics of a pulse detonation engine. Previous experimentation has shown that theoretical efficiency and performance of a pulse detonation engine increases with increase in cycle frequencies. For example, a pulse detonation engine can be designed to operate at a frequency of 100 Hz, which is 100 cycles per second. Injector technology for a pulse detonation engine must be able to operate precisely during each combustion cycle to deliver the desired fuel and air flow profile at these high frequencies to ensure that the mixture detonates rather than deflagrates.

In an effort to meet requirements considered unique to pulse detonation engines, early studies of multi-cycle pulse detonation engines have attempted to use valveless configurations, rotary valves and solenoid driven valves to deliver fuel to the combustion chamber of the pulse detonation engine. For example, in U.S. Pat. No. 7,758,334 B2, issued Jul. 20, 2010, Masayoshi Shimo et al. describe a pulse detonation combustor of valveless construction as an alternative to prior art valved construction. This valveless configuration is intended to eliminate limitations associated with mechanical valves, thereby reducing mechanical complexity of the fuel delivery scheme. Shimo recognizes that his valveless combustor is potentially subject to backflow of hot combustion products. Delivery of fuel and air is controlled by sonic orifice plates and a method of operation referred to as gas dynamic valving controlled by the size of the pulse detonation combustor. The pulse detonation combustor of Shimo et al. cannot readily adapt to differing thrust requirements, operational fuels, and operating environments. Each new operating environment or parameter change would require redesign of the entire pulse detonation engine.

In U.S. Pat. No. 6,505,462 B2, issued Jan. 14, 2003, Gregory Meholic describes a pulse detonation engine having a rotary valve intended to overcome limitations including flexure of the rotating plates and difficulty in maintaining a seal around the rotating plate. Meholic's rotary valves still have drawbacks including the need for a sensor to pick up position and velocity of the valve. Further, Meholic's valve is incapable of modulating the duty cycle of the valve open-time. The inability to modulate open-time is driven by of the inverse relationship between the frequency of rotation and the presented area of the opening in the rotary valve. As the valve rotates faster, the open-time period reduces and less mass flow rate is possible at higher speeds. This creates an inverse relationship of flow rate with frequency, which is undesirable for pulse detonation operations at higher speeds. Although pressure can be increased to increase mass flow rate, this creates other undesirable consequences such as warping of the valve plates. Additionally, rotary valves require a separate drive motor. The rotary motor and rotary motion induces vibrations and electromagnetic interference, which can interfere with the control system. Rotary valves also require rotary seals, which are subject to early failure. The overall complexity of a rotary value solution for managing the flow of fuel or air into a pulse detonation engine is problematic for these and other reasons.

In U.S. Pat. No. 7,464,534 B2, issued Dec. 16, 2008, Emeric Daniau describes another alternative approach for feeding combustible components to the detonation chamber of a pulse detonation engine. A movable flame tube resides within the pulse detonation engine such that for each detonation cycle, the flame tube moves within the pulse detonation engine to create the equivalent of a linear sliding valve arrangement, similar to the rotary approach. Daniau's approach is effectively a hybrid of a rotary valve concept, where the rotational motion has been converted to a linear sliding motion. As with rotary valves, Daniau's approach would still suffer from the inverse relationship between valve operating frequency and valve open period, creating an inability to modulate flow appropriately with frequency.

In U.S. Pat. No. 6,978,616 B1, issued Dec. 27, 2005, Frederick R. Schauer discloses a hybrid engine-pulsed detonation engine structure where fuel is fed to the combustion chamber using a standard gasoline engine poppet valve arrangement along with a reciprocating piston. This mechanical configuration has limited upper operational frequency.

As discussed earlier, solenoid valves have also been considered for use in multi-cycle pulse detonation engines. However, solenoid valves cannot operate at the desired high frequencies due to hysteresis, significant phase lag, and overheating. Additionally, solenoid valves do not have the ability to handle high operating temperatures generated associated with the detonation process. Direct injection gasoline valves and common rail diesel injectors have also been considered as means for fuel injection into pulse detonation engines. Generally, neither has been able to satisfy the high frequency and high temperature operating requirements of the pulse detonation engine.

Consequently, there exists a substantial unmet need for an advanced fuel injector for use in pulse detonation engines wherein the fuel injector has rapid response afforded by direct actuation of the flow control member while delivering dynamic, controlled and variable flow via analog displacement of the flow control member. Correspondingly, there is a need for an actuator to drive the flow control member directly and with variability to accommodate higher frequency and higher pressure operating conditions associated with certain pulse detonation engines.

Still further, there exists a critical, unmet need to provide a pulse detonation engine having a fuel injection system able to control the timing and modulation of fuel and air injection into the combustion chamber of the pulse detonation engine. Further, there exists a desire to incorporate such an injection system having the ability to provide essentially analog control of the fuel:air injection profile during each injection cycle in order to enable varying fuel-to-air ratios at various locations in the detonation tube during each detonation cycle to maximize efficiency of the engine system. Rapid and reliable initiation of detonation in pulse detonation engines is another consideration associated with pulse detonation viability. High operational frequencies and repeatable ignition times are fundamental operational requirements for a pulse detonation engine. Reliable fuel:air mixing techniques are required to ensure propellant mixtures in the main detonation chambers are within the detonability limits for the selected propellant combination.

### BRIEF SUMMARY OF THE INVENTION

In view of the foregoing described needs, embodiments of the present invention comprise a pulse detonation engine having one or more fuel injectors capable of providing: rapid control response, minimal response lag, high frequency operation, delivery of higher fuel flow rates, operationally higher fuel supply and injection pressures, variable and highly granular control of flow during the fuel injection phase of the combustion cycle, control of timing and modulation of fuel injection into the pulse detonation engine combustion chambers, delivery of variable fuel-to-air ratios during the pulse detonation engine detonation cycle, and accommodation of varying fuel types, fuel quality and operating environments.

An embodiment of the present invention comprises a pulse detonation engine including one or more directly actuated piezoelectric fuel injectors capable of operating in variable modes. The first operational mode is on/off where the injector valve is either fully open or fully closed, with no intermediate state. The second mode is continuous where the injector valve can move between fully open or fully closed, or be held at any intermediate position. Continuous control is often called modulating control. It means that the injector valve is capable of moving continually to change the degree of valve opening or closing, which also allows modulation of fuel flow. Thus, the continuously controlled injector valve can seek a plurality of intermediate positions during its operation, not just move to either fully open or fully closed, as with on/off control. In the present injector, a primary flow control member serves as the opening and closing portion with the piezoelectric stack providing the force to proactively drive the flow control member either continuously or in an on/off mode.

Another embodiment of the present invention comprises an array of pulse detonation engines comprising two or more fuel injectors used to deliver fuel for combustion into one or more combustion/detonation tubes. Each injector comprises a piezoelectric driving stack and a flow nozzle assembly wherein a flow control member of the injector is driven directly by the piezoelectric stack without interposing elements including additional amplification means while the flow area of the nozzle portion is variably adjustable with high resolution and granularity to deliver controlled flow rates in a desired flow profile. The injector is adapted to support desired flow rates with miniscule linear movement of the sealing surface of the flow control member away from a sealing portion of the nozzle. Thus, the injector is able to accommodate the prior issue associated with limited displacement limitations of piezoelectric actuating mechanisms.

Another embodiment of the pulse detonation engine includes one or more injectors, wherein each injector comprises a cylindrical housing, a cylindrical flow control member, a piezoelectric driving stack, and a flow nozzle portion wherein the flow control member is directly controlled by the piezoelectric stack without additional amplification means or interposing elements. The piezoelectric stack is controlled via a control system with drive electronics comprising a power amplifier, filters, and a processor providing custom design of a driving waveform and a user interface providing user control of said waveform in real time, along with management of the waveform via pre-programmed behaviour using software associated with the control system. The current and voltage delivered to the stack which establishes the amount of expansion or contraction of the piezoelectric stack from a prestressed state is controlled by these drive electronics. The drive electronics are suited to the control of the piezoelectric stack having miniscule displacement such that the flow control member can be moved a miniscule distance while the flow area can be adjusted with high granularity to deliver a desired fuel flow rate. Thus, the pulse detonation engine is configurable in several versions including a single tube configuration using separate air and fuel injectors, a multi-tube linear pulse detonation engine array, and a multi-tube cylindrical array. In addition, each of the injectors can be tasked and timed for operation to deliver variable thrust requirements. Further, where multiple injectors are used, each injector can be timed to increase the granularity of control wherein the timing for each injector is different from other injectors. Given the ability to control injection via the control system, certain injectors can also be tasked as backup injectors in the event of a failure of one or more primary injectors, thus ensuring reliable operation in critical circumstances.

The flow control member and nozzle portion of the injector are configured to provide a variably adjustable flow area to deliver controlled flow rates in a desired flow profile despite miniscule movement of the flow control member by the piezoelectric stack. Thus configured, the injector of the pulse detonation engine operates in both an on/off mode and a continuous or modulated mode. The injector is uniquely adapted to support desired flow rates with minimal linear movement of the flow control member away from a shoulder and sealing edge of the nozzle. The actuating piezoelectric stack is placed in a pre-stressed state to ensure the piezoelectric stack is continually in compression during operation to avoid separation or delamination between layers of the piezoelectric stack. In one aspect, pre-stress is applied to the stack by screwing the housing end cap down on top of the stack, thereby applying an initial downward force on the top of the piezoelectric stack. The initial downward force can be adjusted by tightening or loosening the end cap. The flow control member is unseated by a reduction in the piezoelectric stack driving force which, in combination with the contraction of the piezoelectric stack, allows the existing fuel pressure to assist to move the flow control member away from the seat of the nozzle, thus allowing fuel to flow into the combustion chamber at a prescribed rate as determined by fuel type, pressures and available flow area. The control system with drive electronics and associated software are configured to support real-time adaptation over the life cycle of the injector to changes in physical and operational parameters. For example, in certain applications, a pulse detonation engine can be asked to deliver initial high levels of thrust at launch, reduced thrust after reaching cruising altitude, and then increased thrust at a reentry or impact phase. In one version of the pulse detonation engine, where operational parameters can change during a mission or individual flight, the injector includes an adaptable nozzle wherein the flow control member and shoulder of the injector interact to create a continually conforming seal during use. The control system adapts the changing flow characteristics of the changes in the conforming seal, wherein a desired flow rate and profile are maintained despite any change in flow geometry between a nose of the flow control member and the shoulder. The control system and its sensors, in combination with the control software and drive electronics, are configured to adjust the displacement of the piezoelectric stack in real-time and, hence, the displacement of the flow control member, to maintain the desired fuel flow profile. Given the flexibility in operation, the trajectory and flight of a pulse detonation engine can be optimized by both pre-programming and in-flight adaptive control, using the dual operating modes associated with the injector, including on/off and continuous.

### BRIEF DESCRIPTION OF THE SEVERAL VIEWS OF THE DRAWINGS

These and other features, aspects and advantages of various embodiments of the present invention will become better understood with regard to the following description, appended claims, and accompanying drawings where:

FIG. 1 shows a perspective view of a fuel injector for use in a pulse detonation engine, according to the present invention;

FIG. 2 shows an exploded view of the fuel injector of FIG. 1;

FIG. 3 shows a cross-section view of the fuel injector shown in FIG. 1, taken along the cutting plane 3-3;

FIGS. 3A and 3B show an enlarged view of the cross-section in FIG. 3, wherein FIG. 3A shows the fuel injector in a closed state and FIG. 3B shows the fuel injector assembly in an open state;

FIG. 4A shows a right side elevation view of the fuel injector housing of the injector shown in FIG. 1;

FIG. 4B shows a front side elevation view thereof;

FIG. 4C shows a top plan view thereof;

FIG. 4D shows a bottom plan view thereof;

FIG. 5A shows a side elevation view of the flow control member of the fuel injector shown in FIG. 2;

FIG. 5B shows a top plan view thereof;

FIG. 5C shows a bottom plan view thereof;

FIG. 6A shows a top plan view of the end cap of the fuel injector shown in FIG. 2;

FIG. 6B shows a bottom plan view thereof;

FIG. 6C shows a side elevation view thereof;

FIG. 6D shows a cross-section view thereof;

FIG. 7A shows a diagram of flow control during a fuel injection cycle wherein a) represents on and off operation of a typical injector and b) represents the analog and variable control afforded by the injector according to the present invention;

FIG. 7B shows a chart of resulting flow velocity and flow areas as a function of the driving overpressure for the fuel injector nozzle to achieve a flow rate of 35 g/s of fuel; and

FIG. 7C shows a chart of Reynolds Number and flow areas as a function of the driving overpressure for the fuel injector nozzle to achieve a flow rate of 35 g/s of fuel.

FIG. 8 shows a perspective view of a single tube pulse detonation engine having two injectors according to one embodiment of the present invention;

FIG. 9 shows a cross-section view of the pulse detonation engine of FIG. 8, according to one embodiment of the present invention;

FIG. 10 shows a cutaway perspective view of FIG. 8, illustrating the arrangement of the injectors in the injection end of the detonation tube of the pulse detonation engine according to one embodiment of the present invention;

FIG. 11 shows a cross-sectional blowup view of the injector arrangement shown in FIG. 10, according to one embodiment of the present invention;

FIG. 12 shows a second embodiment comprising a linear array of single tube pulse detonation engines, according to the present invention; and

FIG. 13 shows a third embodiment comprising a cylindrical array of single tube pulse detonation engines, according to the present invention.

FIG. 14 shows a fourth embodiment comprising a pulse detonation engine having multiple injectors along the detonation tube, according to the present invention.

### OBJECTIVES OF THE INVENTION

A first objective of an embodiment of the present invention is to provide a pulse detonation engine operable with a directly actuated, piezoelectrically driven injector capable of providing desired flow volume and granularity of control to meet operational requirements of the pulse detonation engine.

Another objective is to provide a pulse detonation engine capable of sustained operation over the course of a planned operational profile or mission.

Another objective is to provide a pulse detonation engine wherein control of fuel injection is optimized and enhanced to accommodate different types, mixtures, grades, conditions and sources of fuel, such that fuel consumption is also optimized, thereby significantly improving fuel efficiency, reducing the emission of harmful air pollutants, enhancing power and modulating acoustic emissions as required by operational considerations.

Another objective is to provide a pulse detonation engine where the operational profile is programmable to allow selection and balance between performance, power, efficiency, and emissions based upon the particular application and use.

Another objective of the present invention is to provide a pulse detonation engine having a fuel injection system with minimal control signal response lag to improve operational and inflight stability, particularly when incorporated into a closed-loop feedback control system, allowing controlled changes to be made both within and between injection cycles.

Another objective is to provide a pulse detonation engine having a fuel injection device operated electronically rather than mechanically, eliminating the need for rotary and sliding valve elements.

Another objective is to provide a pulse detonation engine having an injector where the actuator displacement of the injector is sized to avoid inclusion of a sliding seal, thereby supporting the use of a flexible seal that wobbles rather than slides within the chamber of the injector.

Another objective is to provide a pulse detonation engine having a fuel injection system wherein the backpressure on the nozzle and flow control member of the injector can be adjusted via changes to a downstream flow orifice, and, the downstream flow orifice can be sized to govern the operational limits of the pulse detonation engine to avoid runaway combustion.

Another objective is to provide a pulse detonation engine with an injector capable of operating in both an on/off mode and a continuous mode to provide flexibility in pre-programmed behavior of the pulse detonation engine to optimize fuel consumption during an operational profile.

Another objective is to provide a pulse detonation engine having an injector wherein the flow control member and nozzle shapes can be readily adjusted or replaced to deliver different operational profiles or support the use of variable fuels, while using the original piezoelectric actuating mechanism.

Another objective is to provide a pulse detonation engine having an injector wherein the surface of the nose of the flow control member and the sealing portion of the inner nozzle surface continually conform to each other during operation, and a control system integrating flight and engine parameters can continually adjust to meet preprogrammed requirements.

### DETAILED DESCRIPTION OF THE INVENTION

### Elements and Reference Numerals

For ease in review, a table of elements and associated reference numerals is provided below:

| ELEMENT | REFERENCE NUMERAL |
|---|---|
| injector | 10 |
| injector housing | 20 |
| body | 21 |
| inlet | 22 |
| fuel passage | 23 |
| bottom | 24 |
| upper threaded portion | 26 |
| inner chamber | 30 |
| inner wall | 32 |
| inner nozzle surface | 34 |
| outlet nozzle | 36 |
| annular flow area | 37 |
| shoulder | 38 |
| sealing edge | 39 |
| flow control member | 40 |
| crown | 42 |
| seal grooves | 44 |
| body | 46 |
| nose | 48 |
| end cap | 50 |
| penetration | 52 |
| inner threaded portion | 54 |
| seals | 60 |
| piezoelectric stack | 70 |
| cables/conductors | 72 |
| lower portion | 80 |
| upper portion | 90 |
| pulse detonation engine | 100 |
| detonation tube | 110 |
| combustion chamber | 112 |
| injection end | 120 |
| injector ports | 122 |
| thrust end | 124 |
| igniter | 130 |
| first fuel supply line | 140 |
| second fuel supply line | 150 |
| linear thrust array embodiment | 200 |
| linear enclosure | 210 |
| supply line | 250 |
| cylindrical thrust array embodiment | 300 |
| cylindrical enclosure | 310 |
| supply line | 350 |
| multi-injector embodiment | 400 |
| multi-injector detonation tube | 410 |
| inlet end | 412 |
| thrust end | 414 |
| primary oxidizer inlet | 422 |
| fuel supply line | 450 |

The following description is merely exemplary in nature and is in no way intended to limit the invention, its application, or its uses.

### Fuel Injector/Valve

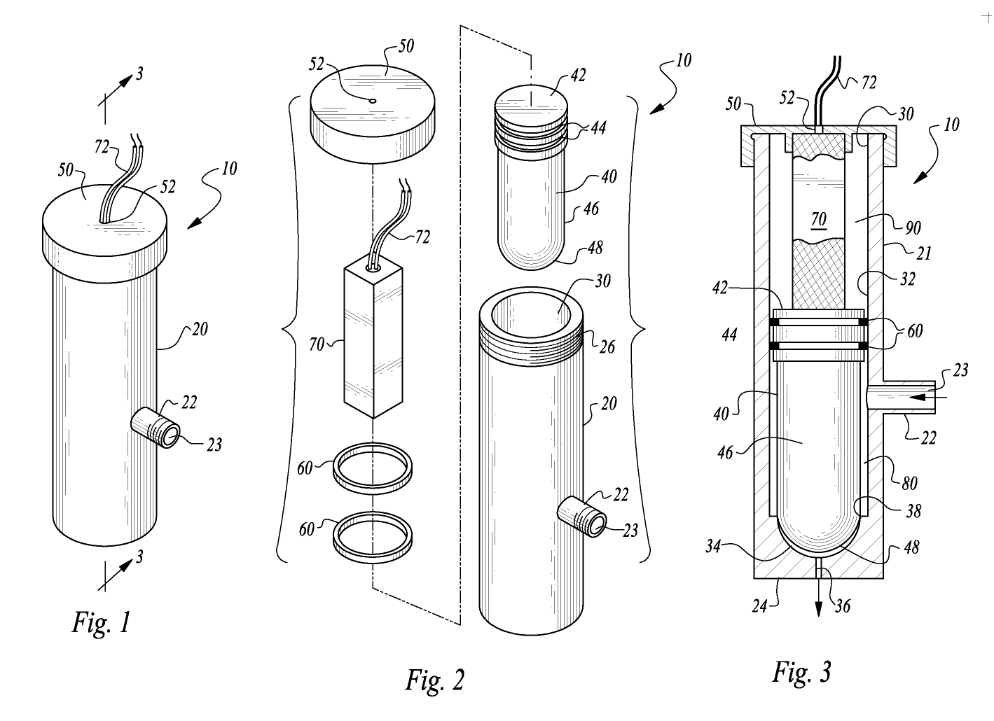

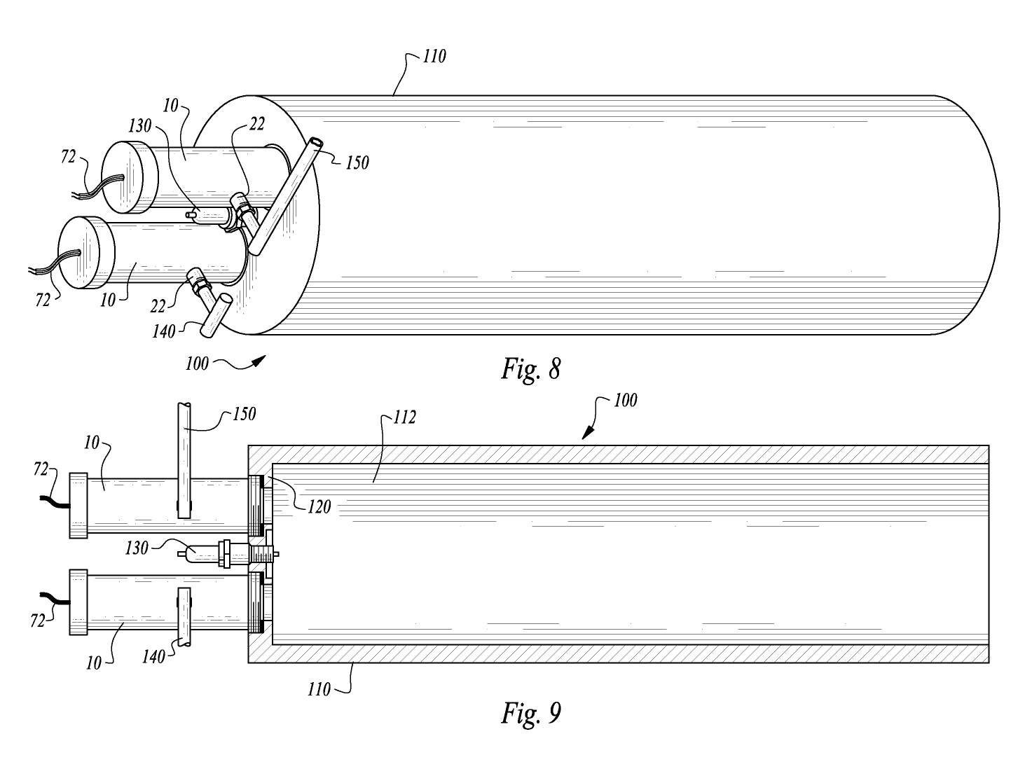

As illustrated in FIG. 1, a valve or fuel injector 10 for use in a pulse detonation engine serves as a flow control valve. According to an embodiment of the present invention, the fuel injector 10 for use with a pulse detonation engine 100 (see FIG. 8) includes an injector housing 20 having a circular end cap 50. As illustrated in FIG. 2, an exploded view of the injector 10 is shown including the injector housing 20 having an inner cylindrical chamber 30 for slidably receiving a cylindrical flow control member 40. Seals 60 circumscribe a crown 42 of the flow control member 40 having cylindrical seal grooves 44 to create sealing engagement with an inner wall 32 of the inner cylindrical chamber 30. As shown, the seals 60 are ring-shaped to conform to the shape of the crown 42 of the flow control member 40 and inner cylindrical chamber 30. The seals 60 provide a pressure seal between a lower portion 80 of the inner cylindrical chamber 30 through which pressurized fuel flows and an upper portion 90 of the inner cylindrical chamber 30 that encapsulates the piezoelectric stack 70. The flow control member 40 is in direct contact with the piezoelectric stack 70. One skilled in the art would recognize that only one seal 60 could be used, or a plurality of seals could be used, as dictated by pressure containment requirements. Additionally, various seal configurations could be further supported by the inclusion of other sealing material or fluids within the upper portion 90 of the inner cylindrical chamber 30 of the injector 10. Such fluid-based sealing options could incorporate a pressure compensation bladder to allow movement of the flow control member 40. Such fluid-based sealing options would also provide additional means for insulating the piezoelectric stack 70 by including a non-conductive fluid. The fluid-based sealing system could also provide a means for providing thermal control to the stack via insulating properties or heat transfer properties. Further, the sealing means could have different geometric shapes, such as chevron or other geometric seals used in hydraulic applications. Still further, the seals 60 can be made of different deformable materials such as rubber, nylon, ceramic, elastomer, graphite, VITON, polyurethane, nitrile, metal and other such materials capable of separating the pressured fuel delivered via the lower portion 80 of the inner cylindrical chamber 30 from the upper portion 90 of the inner cylindrical chamber 30 encapsulating the piezoelectric stack 70.

Additionally, in light of the ability of the injector 10 according to an embodiment of the present invention to leverage a miniscule displacement of the flow control member 40 while providing annular flow area 37 to accommodate a desired flow rate, the seals 60 are essentially stationary where they engage the inner cylindrical chamber 30 of the injector housing 20 and the flow control member 40, such that the seals 60 themselves flexibly deform to accommodate the displacement, d, of the driven flow control member 40. This approach eliminates wear within the inner cylindrical chamber 30 and redirects any potential wear directly to the seals 60, thereby reducing the cost of maintenance where only the seals 60 need be replaced from time to time, rather than the injector housing 20 or its inner cylindrical chamber 30.

Other seal types could be used to ensure a pressure seal within the injector housing 20 without departing from the spirit and scope of the various embodiments and aspects of the present invention. For example, where translation of the flow control member 40 is accommodated by deformation of the seals 60, the seals 60 can also be seated in additional groves in the inner wall 32 of the inner cylindrical chamber 30 to minimize any seal movement along the wall 32. Additionally, the seals 60 are made from material sufficiently resistant to higher operational temperatures associated with the pulse detonation engine while retaining sufficient flexibility to allow translation of the flow control member 40 within the inner cylindrical chamber 30 of the injector housing 20. Where the flexibility of the seals 60 changes, the control system will adapt the driving force of the piezoelectric stack 70 to accommodate either more or less rigidity in the seals 60. Further, in an alternative embodiment, the seals 60 are made of material sufficiently rigid but springable to provide a spring-response in the translation of the flow control member 40 without losing the direct drive associated with the piezoelectric stack 70. The control system adapts to change the output of the piezoelectric stack 70 according to direction of any force exerted on the flow control member 40 by the spring response of the seals 60. Hence, in additional to applying prestress on the stack using the end cap 50, prestress can alternatively be applied via the configuration of the seals 60. Since the spring loading associated with the seals 60 is applied in parallel with the force exerted by the piezoelectric stack 70 on the flow control member 40, the problem of valve float is eliminated due to the continuous direct actuation of the flow control member 40 by the piezoelectric stack 70.

The piezoelectric stack 70 acting as a driving member for controlling the position of the flow control member 40 within the inner cylindrical chamber 30 is interposed between the flow control member 40 and the end cap 50. The piezoelectric stack 70 actively retracts and drives the flow control member 40 within the inner cylindrical chamber 30 of the injector housing 20 of the injector 10.

The injector housing 20 includes a body 21 with an inlet nozzle 22 penetrated by a flow passage 23 for ingress or receiving pressured fuel from an external fuel source (not shown). The injector housing 20 includes a bottom nozzle portion 24, and an upper threaded portion 26 for attachment of the end cap 50 to the injector housing 20. As shown in FIG. 2, the flow control member 40 includes a circular crown 42 above cylindrical seal grooves 44, and a body 46 having a hemispherical nose 48 with a first radius of curvature. The piezoelectric stack 70 includes conductors 72 for delivering electrical power to operate the piezoelectric stack 70. The end cap 50 includes a penetration 52 through which the conductors 72 exit the inner cylindrical chamber 30 of the injector housing 20 to connect to a separate control system (not shown) which powers the stack 70 to expand and contract at a desired frequency and displacement, d. The control system includes software, drive electronics comprising a power amplifier, power filters, and a processor providing custom design of a driving waveform; and a user interface providing user control or software control of said waveform in real time based upon feedback from one or more sensors. The current and voltage delivered to the stack 70 via conductors 72 establishes the amount of expansion or contraction of the stack 70 from a prestressed state as determined and controlled by the drive electronics.

Additionally, the control system is adapted to support operation of the injector 10 in both a continuous and an on/off mode. The control system assists in further minimizing response lag associated with the operation of the piezoelectric stack 70 to support higher frequency operation, allowing the control system to deliver a driving waveform to operate the injector 10 at high frequency and with great granularity in movement of the flow control member 40.

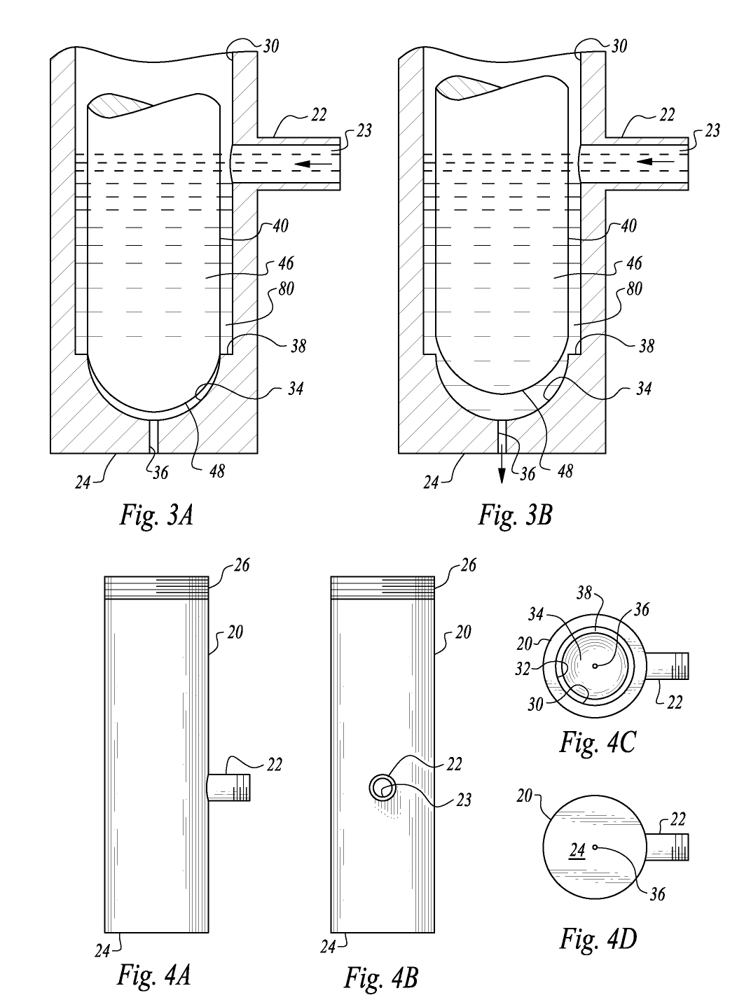

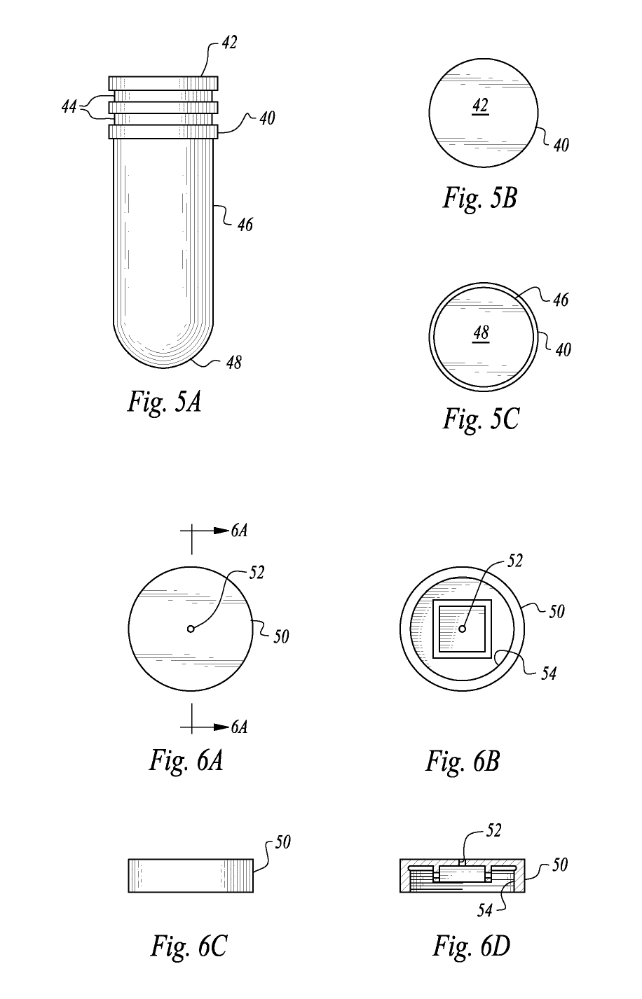

Now, in even greater detail, FIG. 3 provides a cross-sectional view of the assembled injector 10 shown in FIG. 1 taken along the cutting plane described by line 3-3. The injector housing 20 includes a body 21 with an inlet nozzle 22 having a flow passage 23 for receiving pressurized fuel into a lower portion 80 of the inner cylindrical chamber 30 of the injector 10. The injector housing 20 further includes a bottom nozzle portion 24 penetrated by an outlet nozzle 36 for egress of fuel from the injector 10 and through which fuel is delivered to the combustion chamber 112 of the detonation tube 110 of the pulse detonation engine 100. The inner cylindrical chamber 30 includes an inner wall 32. Cylindrical seal grooves 44 of the flow control member 40 are sized to receive and seat circular seals 60 to create a seal separating a lower portion 80 from an upper portion 90 of the inner cylindrical chamber 30. The lower portion 80 receives and transfers pressurized fuel to the combustion chamber 112.

With reference to FIGS. 3A and 3B, the operation of the injector 10 is shown. In a closed state, as shown in FIG. 3A, the nose 48 of the flow control member 40 is seated against a sealing edge 39 of a shoulder 38 of the inner cylindrical chamber 30 and prevents the flow of fluid The shoulder 38 circumscribes the inner nozzle surface 34. The inner cylindrical chamber 30 includes a concave inner nozzle surface 34 having a second radius of curvature C2 smaller than a first radius of curvature C1 of the nose 48 of the flow control member 40, causing the nose 48 and sealing edge 39 to create a sealing interface to prevent fuel flow. The limited area of the sealing interface lessens the force necessary to disengage the flow control member 40 from the sealing edge 39 during opening. In a closed state, pressurized fuel resides in the lower portion 80 of the inner cylindrical chamber 30 formed by the body 46 of the flow control member 40, the shoulder 38, and the seals 60 surrounding the circular crown 42 of the flow control member 40. In operation, with power removed from the stack 70, the stack 70 expands in a fail-safe mode to seat the flow control member 40 on the sealing edge 39 to interrupt fuel flow.

To reach an open state, as shown in FIG. 3B, the downward force delivered by the piezoelectric stack 70 is reduced to retract the nose 48 of the flow control member 40 away from the shoulder 38. Once the stack 70 has retracted the flow control member 40, the force generated by the pressure of the fuel against the flow control member 40 provides a momentary additional opening force to assist in opening the injector 10. During opening and throughout its operation, the position of the nose 48 of the flow control member 40 is proactively controlled by the stack 70 to maintain a desired position in order to create an annular flow area 37 appropriate to a desired flow rate. While open, pressurized fuel flows through the flow passage 23 of the inlet nozzle 22 into the lower portion 80 of the inner cylindrical chamber 30 and through the outlet nozzle 36 for egress into the combustion chamber 112 of the detonation tube 110 of the pulse detonation engine 100.

The expansion or contraction of the piezoelectric stack 70 is controlled with granularity to allow precise control of the movement of the flow control member 40, hence resulting in corresponding precise control over the rate of fuel flow. Coupled with the geometric configuration of the injector 10 wherein the first radius of curvature C1 of the nose 48 of the flow control member 40 is juxtaposed against the second radius of curvature C2 of the inner nozzle surface 34, more precise control of rate of flow is afforded.

In operation, the fuel injector 10 creates a dynamic annular flow area 37 providing precise variable control of fuel flow from the injector 10 into the combustion chamber 112. Precise control is afforded by direct actuation of the flow control member 40 by the piezoelectric stack 70. This direct actuation delivers controlled variability of the annular flow area 37 to provide variable fuel delivery profiles to optimize engine performance for efficiency, distance, power, velocity, emission control, or any combination of multiple performance objectives. Integration of the fuel injector 10 with other sensors, control circuitry, and operational intelligence delivers enhanced engine and vehicle control, shifting actuation methods from primarily mechanical to primarily electronic means.

As previously described and illustrated in FIG. 3A-3B, the injector 10 injects fuel at an appropriate rate despite significantly reduced linear displacement, d, of the flow control member 40. In an embodiment of the present invention, the injector 10 is configured to leverage a first larger radius C1 of the nose 48 of the flow control member 40 juxtaposed against a second smaller radius C2 of the inner nozzle surface 34. Furthermore, the diameter of the flow control member 40 and associated inner cylindrical chamber 30 is sized to allow adequate fuel flow despite minimal linear displacement, d, of the flow control member 40. The surface profiles of the nose 48 of the flow control member 40, shown as differing in the radii of curvature, represent only one variation of a plurality of available surface profiles which can be adapted for use in the injector 10.

In the present embodiment, the inner nozzle surface 34 includes an outlet nozzle 36 that penetrates the bottom nozzle portion 24 of the injector housing 20. The outlet nozzle 36 can be sized to either limit the flow of fuel or not limit the flow of fuel, irrespective of the flow enabled by the displacement, d, of the flow control member 40. The outlet nozzle 36 can be sized to limit the flow to a prescribed upper limit. Consequently, an engine system can be designed to constrain maximum fuel flow to a specified limit. Additionally, in an additional embodiment, the outlet nozzle 36 can be removed in its entirety such that the fuel flow is determined solely by the displacement, d, of the flow control member 40 and the geometric relationship between the nose 48, the shoulder 38, and the inner nozzle surface 34.

FIG. 4A shows a right side elevation view of the fuel injector housing 20 of the injector 10 shown in FIG. 1. The housing 20 includes an inlet 22 for fuel ingress, a bottom 24 for attachment to the combustion chamber of an engine, and an upper threaded portion 26 through which the flow control member 40 and piezoelectric stack 70 can be loaded into the housing 20. FIG. 4B shows a front side elevation view of the injector 10 further depicting the inlet 22 and its fuel passage 23. FIG. 4C shows a top plan view of the injector housing 20 having an inner cylindrical chamber 30 with an inner wall 32. The inner cylindrical chamber 30 includes an inner nozzle surface 34 near the bottom 24; the inner nozzle surface 34 circumscribed by a shoulder 38. The inner nozzle surface 34 and bottom 24 are penetrated by an outlet nozzle 36. FIG. 4D shows a bottom plan view of the injector housing 20, depicting the location of the outlet nozzle 36 in the center of the bottom 24.

Now, referring to FIG. 5A, a side elevation view of the flow control member 40 of the fuel injector 10 is illustrated. The flow control member 40 includes a crown 42 for engagement with the piezoelectric stack 70, seal grooves 44 for receiving seals 60, a body 46 which extends to a nose 48 for engagement with the shoulder 38 of the inner nozzle surface 34. FIG. 5B shows a top plan view of the flow control member 40 emphasizing the circular crown 42. FIG. 5C shows a bottom plan view of the flow control member 40 wherein the nose 48 extends from the body 46. The body 46 and housing 20 can both be lengthened or shortened to accommodate differing operational requirements including establishing a particular reservoir volume of fuel within the lower chamber 80 as a precursor to injection.

FIG. 6A-6D illustrate various views of the end cap 50. The end cap 50 is circular, having a centered penetration 52 for passage of electrical conductors 72 to control the application of current and voltage to the piezoelectric stack 70. FIG. 6B shows a bottom plan view of the end cap 50, illustrating the inner threaded portion 54 for engagement with the upper threaded portion 26 of the injector housing 20. In one aspect, the end cap 50 can be adjusted to apply prestress to the piezoelectric stack 70.

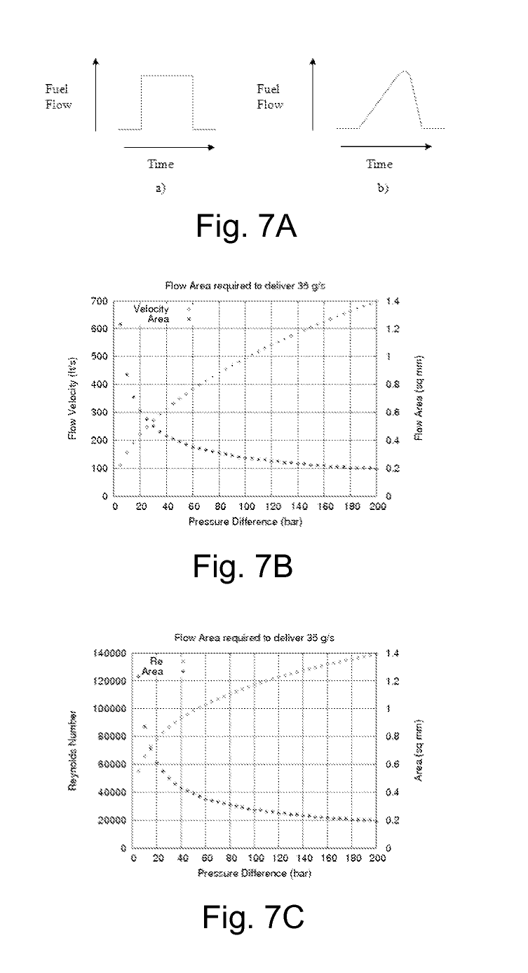

Now referring to FIG. 7A-7C, various operational modes are illustrated. FIG. 7A shows a diagram of flow control during two representative fuel injection cycles. The first, a), represents on and off operation of a typical injector and one mode of operation for the injector 10. The second, b), represents a second mode of operation available via the injector 10 including analog and variable control allowing modulation of fuel flow throughout each injection/detonation cycle. As earlier indicated, the fuel injector 10 operates in dual modes including both on/off and continuous, modulated control. FIG. 7B is a chart depicting required flow velocity and flow areas as a function of the driving overpressure for the fuel injector nozzle 10 to achieve a flow rate of 35 g/s of JP-10 fuel. This flow rate was selected as a preferred flow rate for one embodiment of the pulse detonation engine 100. Additionally, FIG. 7C is a chart indicating Reynolds Number and flow area as a function of the driving overpressure for fuel injector to achieve a flow rate of 35 g/s of JP-10 fuel. These charts are illustrative of one operational scenario; other operational scenarios and fuel flow rates are accommodated by the flexibility of the injector 10.

Based upon response of the piezoelectric stack 70 and the control system, the injector 10 accommodates a range of typical operating frequencies for various injection systems. These operating frequencies can include frequencies upward of several hundred Hertz (Hz) or even thousands of Hz. Hence, the operational frequency of the injector 10 can be adapted to support an operating frequency range between just a few Hz and 1000 Hz. Reconfiguration of the design of the piezoelectric stack 70, the housing 20 and flow control member 40 along with the inner nozzle surface 34 and nose 48 will support further increase in operating frequencies.

Further, the drive electronics and associated software support a plurality of changes in displacement, d, throughout each injection/detonation cycle, providing enhanced granularity and support of optimal performance where operational enhancement is achieved via delivery of adjustments during each injection cycle. For the pulse detonation engine 100, an operational frequency between 0 Hz and 200 Hz is preferable.

In addition to the provision of adaptive control and modulation of the flow rate, the drive electronics and associated software include intelligence to detect and identify operational limitations of each piezoelectric stack 70 based upon its natural resonant frequency. This detection capability prevents the piezoelectric stack 70 from operating at frequencies that might quickly degrade operation of the injector 10. For stable operation, the pulse detonation engine 100 will operate in a mode that ensures that operational frequency of the injector 10 is below the resonant frequency of the piezoelectric stack 70. In one embodiment, the piezoelectric stack 70 are selected such that the resonant frequencies are 40 kHz or above. Hence, where the operating frequency of a pulse detonation engine 100 is in the range of 200 Hz, the injector 10 avoids approaching this critical resonant frequency, ensuring longer operational life of the piezoelectric stack 70.

Further, the injector 10 and drive electronics are harmonized to create waveforms to drive the piezoelectric stack 70 at frequencies from 0 Hz to 1000 Hz, and, the piezoelectric stack 70 and drive electronics are optimally harmonized to leverage these higher drive frequencies. Coordinated with the responsiveness of the piezoelectric stack 70, control signal response lag is reduced to improve operational stability of the injector 10. This operational stability increases in importance when the injector 10 is incorporated with the drive electronics in a closed-loop feedback control system to allow controlled changes in operation to be made both within and between cycles.

Where the injector 10 is adapted to other operational parameters and requirements, other alterations to the stack 70 can be implemented to avoid operating within a resonant frequency window. For example, in extreme cases where a large piezoelectric stack 70 is used to deliver significant displacement at high frequencies, the resonant frequency can be approached. For example, an 800 mm piezoelectric stack 70 would have a resonant frequency in the low kHz regime, such as around 2 kHz. If operational frequency were in the 1 kHz range, this frequency proximity would be undesirable, necessitating other changes to the piezoelectric stack 70 to raise the resonant frequency.

### Valve/Fuel Injector Design and Operation

Now, the rationale for the design and operation of the injector 10 is described. First, we accommodate miniscule displacement of the flow control member 40 away from the shoulder 38 driven by the use of a piezoelectric stack 70 as the direct actuator of the flow control member 40. The accommodation is achieved via a nonconforming flow control configuration incorporated in the fundamental design of the injector 10. In typical injector configurations, the flow control member of a fuel injector, commonly known as a “pin” or “needle,” has a diameter just slightly larger than the orifice through which fuel is jetted into the combustion chamber of an engine. The pin in a conventional injector is simply used to shut flow on and off, and hence, the orifice serves as the primary means of flow control. Consequently, typical injector configurations cannot adjust flow without changing the size of the orifice. This limitation prevents typical injectors from adapting to or accommodating varying fuel types, operating conditions, and performance requirements.

For one set of operating parameters used herein, including operating pressures and desired fuel flow rate, in a typical injector, the pin (flow control member) is sized to close off an orifice having a diameter of approximately 1 mm. However, in stark contrast, in the present embodiment of the invention, the body 46 of the flow control member 40 has a diameter of approximately 15 mm. One skilled in the art would recognize that the diameter of the flow control member 40 can be adapted to various flow requirements, and can be scaled up or down as desired.

Thus, the injector 10 of the present embodiment of the invention takes a directly contrary approach to conventional injector configurations by distinctly modifying the physical size and relationship between the flow control member 40 and the displacement of the flow control member 40 made available by the piezoelectric stack 70, thereby transforming the control point from the static orifice of the conventional injector to the variable flow area 37 of the injector 10 of the present invention. The displacement, d, of the piezoelectric actuator stack 70 is typically tens of microns. Hence, to accommodate a desired flow rate, the housing 20 of the injector 10 is sized to accommodate a much larger flow control member 40 to provide a significantly greater annular flow area 37 around the nose 48 of the flow control member 40. The available flow area is determined by the restriction, the annular flow area 37, which is defined by the nose 48 of the flow control member 40 as it is translated linearly away from, or toward, the shoulder 38 of the inner nozzle surface 34 by the piezoelectric actuating stack 70.

In comparison, for conventional fuel injectors having a needle diameter slightly greater than 1 mm and effective orifice diameter of 1 mm, where the exposed orifice area is considered independent of the displacement, d, the calculated flow area of a 1 mm diameter orifice is 0.125 sq. mm. Based upon desired flow rates, operational pressures, and a selected fuel type of JP-10, a flow area of 0.125 sq. mm. is insufficient to achieve the desired flow rates. Hence, in a conventional injector, the small flow control member, in this case, the “pin” or “needle,” is a bottleneck that is not adjustable without completely replacing the orifice. This typical injector nozzle configuration is not dynamically adaptable.

Now, we turn to the operational features of the injector 10 that support stable operation of the pulse detonation engine 100. First, when considering various size constraints and operating parameters, the height of the piezoelectric stack 70 determines the available displacement, d. As the height of the piezoelectric stack 70 is varied, the displacement, d, also varies. Within a certain operating envelope, by expanding the diameter of the flow control member 40 significantly, a desired effective flow rate can be maintained despite miniscule displacement, d, of the stack 70.

The injector housing 20 is adaptable to a range of operational needs. While the exemplar accommodates piezoelectric stacks 70 having a total length of 40 mm, the length of the housing 20 can be reduced to accommodate smaller stack sizes and reduced displacement, d. Alternatively, the length of the injector housing 20 can be increased to accommodate larger piezoelectric stacks 70, which will deliver greater maximum displacement, d, and greater maximum force. Further, the injector housing 20 can be sized for a particular stack size, but can accommodate piezoelectric stacks 70 of smaller total size than the maximum space available in the injector housing 20 via the use of stiff spacers to fill the remaining void between the crown 42 of the flow control member 40 and the end cap 50.

The upper chamber 90 of the injector housing 20 can be filled with one or more stacks 70 in any combination. For example, where the upper chamber 90 is sized to accommodate 40 mm, the options include: 1) a single 40 mm stack; 2) two piezoelectric stacks of 20 mm; 3) one 30 mm stack and one 10 mm stack, and, 4) any other such combination, including spacers, totaling 40 mm.

In a multi-stack arrangement where the stacks are stacked linearly in series, the stacks 70 can be connected electrically in parallel to drive electronics such that the stacks 70 act in unison to maximize total displacement, d. Alternatively, one or more of the stacks 70 can be connected to a separate drive electronic module of the control system. In this manner, each stack 70 can be operated independently in different applications. For example, by electrically driving each stack 70 independently, one or more of the stacks 70 can be used to prestress the remaining stacks 70 dynamically, supporting adaptation to current operational environmental parameters and system requirements. Since the upper portion 90 of the inner cylindrical chamber 30 of the injector housing 20 does not contain fluid under pressure, the injector 10 also supports adaptation of a modular approach such that the injector housing 20 can be constructed in one or more sections. This modular configuration reduces machining requirements of long components. When one or more stacks 70 are operated in series, the total displacement, d, of the multiple stacks 70 is equivalent to the sum of individual displacements of each separate stack.

In operation, and as one representative example, to accommodate desired fuel flow rates for a pulse detonation engine operating on JP-10 fuel, a first embodiment of the pulse detonation engine 100 having an injector 10 according to the invention uses a flow control member 40 having a diameter of 15 mm. A diameter of 15 mm is selected to accommodate a square cross section of a selected piezoelectric stack 70 having side dimensions of 10 mm×10 mm (approximately 14 mm across diagonally) with a total displacement, d, of 40 microns. This correlation between the size of the piezoelectric stack 70 and the diameter of the flow control member 40 is selected herein as one of a plurality of desirable design points that will deliver appropriate performance in a suitable package size for inclusion in various engine applications.

As illustrated in FIG. 3C, in the present embodiment of the invention, the nose 48 of the flow control member 40 has a greater first radius of curvature C1 than the second radius of curvature C2 of the inner nozzle surface 34. The annular flow area 37 prescribed by the separation of the profile of the nose 48 of the flow control member 40 from the profile of the inner nozzle surface 34 varies directly with the linear translation and displacement, d, of the stack 70, thus providing highly granular, analog control of flow. While the stack 70 provides highly resolute motion of the flow control member 40, the inclusion of a nose 48 with a specific profile and an inner nozzle surface 34 having a specific profile further serves to increase the granularity of flow control of the injector 10 and the shape of the fuel flow profile. The operational flow profile of the injector 10 can be adjusted by modifying the curvature of the nose 48 and the inner nozzle surface 34, while using the same piezoelectric stack 70 with the same displacement, d. FIG. 5A-5D and FIG. 6A-6C are representative versions of the various nose profiles and inner nozzle surface profiles, respectively, that might be deployed in different configurations of the injector 10 to deliver differing fuel flow profiles as a function of the displacement, d, of the piezoelectric stack 70. One skilled in the art would recognize that a plurality of variations on these base configurations is possible. Consequently, the operational performance of the injector 10 can be adjusted by changing flow control members 40 wherein each flow control member 40 can have a different nose 48, by changing the inner nozzle surface 34, or both. Although shown herein as comprising several different variations, embodiments of the present invention are not limited to these specific geometric shapes and are adaptable to a plurality of nose 48 and inner nozzle surface 34 profiles and shapes. Additionally, although shown herein as consisting of a single module, the injector housing 20 can include modular components including outlet nozzles 36 that are modular and changeable with differing inner nozzle surfaces 34 which can be screwed or otherwise attached to the bottom nozzle portion 24 of the injector housing 20.

In the present embodiment, the injector 10 includes an outlet nozzle 36 having a significantly smaller diameter juxtaposed against a larger diameter flow control member 40 and nose 48. The nose 48 of the flow control member 40 geometrically interact with the sealing edge 39 of the shoulder 38 and the inner nozzle surface 34 to establish available annular flow areas 37. An alternative embodiment of the present invention does not include an outlet nozzle 36; flow is controlled solely by the geometric interaction between the nose 48 and sealing edge 39 of the shoulder 38. As previously discussed and illustrated in FIG. 6A-6C, other embodiments include differently shaped inner nozzle surfaces 34 which likewise adjust flow rate and pattern. In other aspects of an embodiment of the present invention, the outlet nozzle 36 is sized to limit flow or configured to provide a desired fuel flow spray pattern or droplet size. Additionally, the outlet nozzle 36 includes a means for attachment of the injector 10 to an engine combustion chamber 112 via the inclusion of a threaded, flanged or bolted interface at the bottom nozzle portion 24. Further, in other embodiments, the outlet nozzle 36 is modular and removable from the injector 10. Still further, the outlet nozzle 36 in a removable, modular form serves as an additional means for adjustably or fixedly prestressing the piezoelectric stack 70 in a manner similar to that of an end cap 50, wherein an adjustable desired prestress load is delivered to the piezoelectric stack 70 via rotation of a threaded outlet nozzle 36 to compress the stack 70 via the placement of pressure on the nose 48 of the flow control member 40.

For the exemplar, a fuel supply pressure of 50 bar was assumed. However, the injector 10 is modifiable to accommodate different supply pressures. Further, although the injector housing 20 according to an embodiment of the present invention accommodates piezoelectric stacks 70 having side dimensions of 10×10 mm with a stack height of 20 to 40 mm, the injector housing 200 is scalable up or down to accommodate differing stack sizes and flow requirements.

In one embodiment, during assembly of the injector 10, the end cap 50 is screwed onto the upper threaded portion 26 of the injector housing 20 to seal the injector 10 and apply a prestress to the stack 70. Other means for attaching the end cap 50 and adjusting the desired prestress load are suitable and include the use of finer threads, the inclusion of geared micrometers to control the resolution of the rotation of the end cap, the inclusion of geared stepper motors to automate the control and rotation of the end cap 50, and other similar devices that precisely control the placement of an adjustable or fixed desired prestress load on the piezoelectric stack 70.

In light of the operational conditions associated with the pulse detonation engine 100, the injector 10 is configured to operate at high temperatures and high pressure, as well as with volatile fuel and corrosive chemicals. In the president embodiment, stainless steel was chosen as the preferred material for mechanical and chemical robustness along with ease and practicability of machining. Other materials, including ceramic, would be suitable and adaptable for particular operational requirements.

Referring once again to FIG. 3, in operation, the piezoelectric stack 70 controls the linear movement of the flow control member 40 within the injector housing 20. In testing the injector 10, a displacement, d, of approximately 40 microns is generated using an operational voltage of 200 volts applied to the piezoelectric stack 70. In one embodiment, a single crystal piezoelectric stack 70 comprising 200 single crystal layers, wherein the stack 70 is 20 mm long, meets these operational parameters. In a second embodiment, a standard piezoelectric stack having an approximate height of 40 mm is used to achieve the desired displacement, d, of approximately 40 microns. Typically, for existing piezoelectric materials comprised of piezoceramic material, the available displacement, d, is approximately one-tenth of one percent of the height of the piezoelectric stack, assuming delivery of sufficient electrical power to the stack. The housing 20 of the injector 10 is able to accommodate both a 20 mm and 40 mm stack height where a rigid spacer is placed between the end cap 50 and the top of the stack 70 to fill the remaining space where a 20 mm stack is used. Although a stack 70 composed of single crystal piezoelectric material is substantially more expensive than a stack composed of standard piezoelectric materials, a single crystal piezoelectric stack 70 will allow the injector 10 to be significantly reduced in size since a single crystal piezoelectric will deliver strain of 1% of the stack height, approximately ten times that of a standard stack. As manufacturing costs drop with increased production volume, single crystal stacks will be the preferred choice for use in the injector 10.

The injector housing 20 will accommodate one 20 mm long single crystal stack, one 40 mm standard piezoelectric stack, or two 20 mm single crystal stacks, or two or more stacks of differing heights totaling 40 mm. In addition, where a longer stack is preferable to support other operating parameters, the injector housing 20 can be expanded to hold multiple stacks in either series or parallel configurations. When the stack design incorporates two 20 mm single crystal stacks, the stacks can be axially-aligned to increase displacement, d, where the total displacement is the sum of individual displacements. Alternatively, the stacks can be aligned in opposing orientations such that one stack contracts in one direction while the remainder contracts in another direction, such that each stack delivers force in opposition to the other stack. This opposing contraction provided allows one stack to function as a means for providing both initial and real-time adjustment of prestress on the primary actuating stack. Consequently, the end cap 50 can be used to establish initial prestress while a second stack is used to provide a more resolute and fine-tuned control of prestress. Additionally, the second stack can be used to adjust prestress as the housing 20 of the injector 10 expands or contracts due to the housing material's thermal coefficient of expansion. Further, the second stack can be used to accommodate extension of the driving stack 70 caused by operational deformation of the sealing edge 39.

In use and operation, compressive prestress forces are placed on the stack 70 to ensure the piezoelectric crystal layers are never placed in tension, where the ceramic piezoelectric material is weaker and the bonds between layers are weaker. In most circumstances, prestress is applied to a piezoelectric stack prior to insertion in a system; in an embodiment of the present invention, prestress is applied to the stack 70 after insertion of the stack 70 in the injector housing 20. By applying a desired prestress load after the stack 70 is deployed within the housing 20 of the injector 10, differing means can be used, as discussed above, to adjust the load on the stack 70 during operation to provide real-time calibration during differing operating scenarios.

Initial desired prestress load is applied to the stack 70 via a threaded end cap 50 attached to an upper threaded portion 26 of the injector housing 20. The end cap 50 can be tightened or loosened to vary the prestress on the stack 70. The ability to adjust and vary the prestress load ensures that there is a downward force on the flow control member 40 to resist opposing opening forces caused by high pressures associated with the combustion cycle and associated fuel supply pressure. In the exemplar, it was determined that the downward force on the stack 70 to keep the flow control member 40 closed with a back pressure of 50 bar (6 MPa) is well within the operable stress range of the piezoelectric materials used in the stack 70. Since the stack 70 is initially prestressed and in compression with downward force placed on the flow control member 40 to keep it seated with fuel flow shut off, to operate the injector 10 and lift the flow control member 40 off the shoulder 38, the stack 70 is powered such that it contracts even further than it existing compressed state. This powering method ensures that the stack 70 is never placed in tension, which would damage the stack 70 early in its operational life cycle.

In the present embodiment, the injector 10 accommodates multiple variables associated with control of fuel delivery. In addition, the injector 10 includes an additional means for controlling flow via inclusion of an outlet nozzle 36. The outlet nozzle 36 can be sized to either limit or not limit flow. In one aspect, the diameter of the outlet nozzle 36 is sized to satisfy desired flow rates for the selected engine system, while simultaneously providing an upper flow limit or governing mode. When sized to govern the fuel flow rate to an upper limit, the diameter of the outlet nozzle 36 is determined based on fuel supply pressure, desired maximum flow rate, and fuel properties. For example, in a specific operational test to support pulse detonation engine operation, JP-10 fuel was selected as the preferred fuel type. JP-10 fuel is an aviation turbine fuel and due to its properties is the primary missile fuel used in the U.S. today.

The thermophysical properties of JP-10 fuel are given in a report by T. J. Bruno et al, entitled Thermochemical and Thermophysical Properties of JP-10, published June 2006. For the particular pulse detonation engine design contemplated, the desired fuel flow rate and operating temperature was set at 35 g/s of JP-10 fuel at 300° F. with a minimum desired operating injection frequency of 100 Hz, where each cycle constitutes a full open and close of the valve. In the Bruno report, the sound speed and most other physical quantities are given in the temperature range of 270 K-345 K. At the specified temperature of 300° F. (420 K), most of the physical quantities must be extrapolated. Extrapolating the sound speed curve, the sound speed at 420 K is 975 m/s. For the desired flow requirements, the discharge flow velocity at 200 bars is estimated to be 250 m/s, which is substantially lower than 975 m/s. Consequently, the flow rate of the fuel is in the incompressible range and compressibility effects can be neglected.

For liquid discharge flow through an orifice, the flow rate, q, is given by

q=CA\sqrt{2g144Δp/ρ}

where q is the volumetric flow rate in ft³/s, Cis the dimensionless discharge coefficient (approximately 1, depending on the orifice-to-pipe diameter ratio and the Reynolds number (Re), A is the flow area in ft², g is a units conversion factor (=32.17 lbm-ft/lbf-s²), Δp is the driving overpressure in psi, and ρ is density in lbm/ft³. Other related units conversion factors are: for density, 1 g/cc=1 kg/m³=62.4 lbm/ft³; for pressure, 1 bar=14.50 psi; for viscosity, 1 mPa-s=10⁻³ g/s-mm=0.000672 lbm/ft-s; and for mass, 1 lbm=453.515 g.

The extrapolated density of JP-10 fuel at 420° K is 0.85 kg/m³ (53 lbm/ft³). C_{d}=0.98 for Re˜5×10⁴ which is 0.2% below the asymptotic value of 0.982 for fully turbulent flow. The viscosity extrapolates to 0.68 mPa-s.

The disclosed injector 10 will provide opportunities for substantial improvement in many types of combustion engine designs, significantly improving fuel efficiency and reducing emissions. The size of the injector 10 can be scaled down or up to accommodate varied injection requirements. Standard diesel and jet engines stand to benefit greatly from the superior capabilities of this fuel injector technology due to the ability to deliver analog control of flow. In addition, pulse detonation engines, having unique and rigorous operational requirements that heretofore have been previously unmet, now have a greater opportunity to become a legitimate and viable engine modality using various embodiments of the present invention.

Further, the injector 10 according to various embodiments of the present invention will serve as foundational and pioneering technology to support substantial redesign of today's combustion engine technologies. An important outcome associated with the use of this electronically-controlled, direct actuation piezoelectric injector configuration is the opportunity to eliminate a plethora of existing engine components including rocker arms, push rods, valve springs, cam shafts, timing belts, and associated equipment. These components could be supplanted by one or more versions of the described piezoelectrically driven injector 10.

Although various embodiments of the present invention have been described in considerable detail with reference to certain preferred versions thereof, other versions are possible. For example, a version can be configured such that the inner nozzle surface 34 and the outlet nozzle 36 are removed with flow controlled by the annular gap between the nose 48 of the flow control member 40 and the shoulder 38. In addition, another version can include adaptations, modifications and adjustments to size of the flow control member 40, shape of the nose 48, and shape of the inner nozzle surface 34 to deliver alternative flow characteristics as a function of stack displacement, d. Additionally, versions of the present invention can include multiple stacks which allow further adjustment of the power and displacement of the stack 70 where multiple stacks in parallel increase overall power or force and multiple stacks in series increase overall displacement. Multiple stacks or larger stacks are easily accommodated by increasing either the length or the diameter of the injector housing 20. In addition, versions are possible wherein a second load or prestress adjustment stack is interposed between the end cap 50 and a first driving stack 70 to provide real-time adjustment of prestress on the driving stack 70. Multiple piezoelectric stacks 70 in parallel relation can be used to adjust alignment of the flow control member 40 within the cylindrical chamber 30 of the injector housing 20. Additionally, multiple stacks 70 can be used to skew and vibrate the flow control member 40 as a means of mechanically cleaning any scale or deposits that might accumulate during operation. Still further, an injector 10 according to an embodiment of the present invention hereof can include an operational approach wherein the piezoelectric stack 70 or an ancillary piezoelectric stack is driven at frequencies which would resonate and cause scale and other deposits to be cleaned from the inner cylindrical chamber 30, the inner wall 32, the inner nozzle surface 34, the outlet nozzle 36, the shoulder 38, and the sealing edge 39. In use, an injector 10 having the afore-mentioned capabilities can be used in pulse detonation engine configurations to power tactical aircraft, air-launched and ship-launched missiles, unmanned aerial vehicles, and a wide range of standoff munitions. Integrated with a rocket engine assembly, such a system could be used to power space launch vehicle upper stages, orbit transfer vehicles, excursion vehicles and planetary landers. They can also be used for spacecraft attitude control satellite station keeping, and satellite maneuvering propulsion. Such a pulse detonation engine extends operational features of various military systems for increased range, stealth and reliability for systems in Mach operation range while simultaneously offering reductions in size, vulnerability and cost.

In hybrid arrangements, the pulse detonation engines and the advanced fuel injector 10 can be combined with turbomachinery. In hybrid mode, the pulse detonation engine 100 according to the present invention is used in place of high-pressure compressor stages, combustion chambers, high-pressure turbine stages, afterburners, and augmenters. Additionally, the pulse detonation engine can provide fluidic thrust vectoring, eliminating the need for heavy, high-drag aerodynamic control surfaces.

### Pulse Detonation Engine

FIG. 8 is a perspective view of a pulse detonation engine 100 according to an embodiment of the present invention. The pulse detonation engine 100 is comprised of a detonation tube 110 having an internal combustion chamber 112. The detonation tube 110 includes two injectors 10 for injecting fuel and oxidizer into the internal combustion chamber 112 of the pulse detonation engine 100. The injectors 10 connect to an injection end 120 of the detonation tube 110. Combusted materials exist through an opposing thrust end 122 of the detonation tube 110. Although shown as having two injectors 10, the pulse detonation engine 100 is also operable with only one injector 10. An igniter 130 is interposed between the two injectors 10. A first fuel supply line 140 is connected to the inlet 22 of one injector 10; a second fluid supply line 150 is connected to the inlet 22 of the other injector 10. When configured with two injectors 10 having differentiated supply lines 140, 150, the pulse detonation engine 100 is able to increase fuel injection rate, modify fuel injection flow profile, and introduce fuels of differing types in each injector 10. For example, where one fuel might be of lower quality or lower BTU content, one fuel can be injected by one injector 10 while a higher quality fuel is injected in the other injector 10, thus conserving higher quality fuel while still leveraging the use of the lower quality fuel. The inclusion of two injectors 10 also allows one injector 10 to serve as the primary injector 10, and, the other injector 10 to serve as a spare or supplementary injector 10. Additionally, thus configured in an additional operation mode, one injector 10 supplies fuel; the other injector 10 suppliesoxidizer.

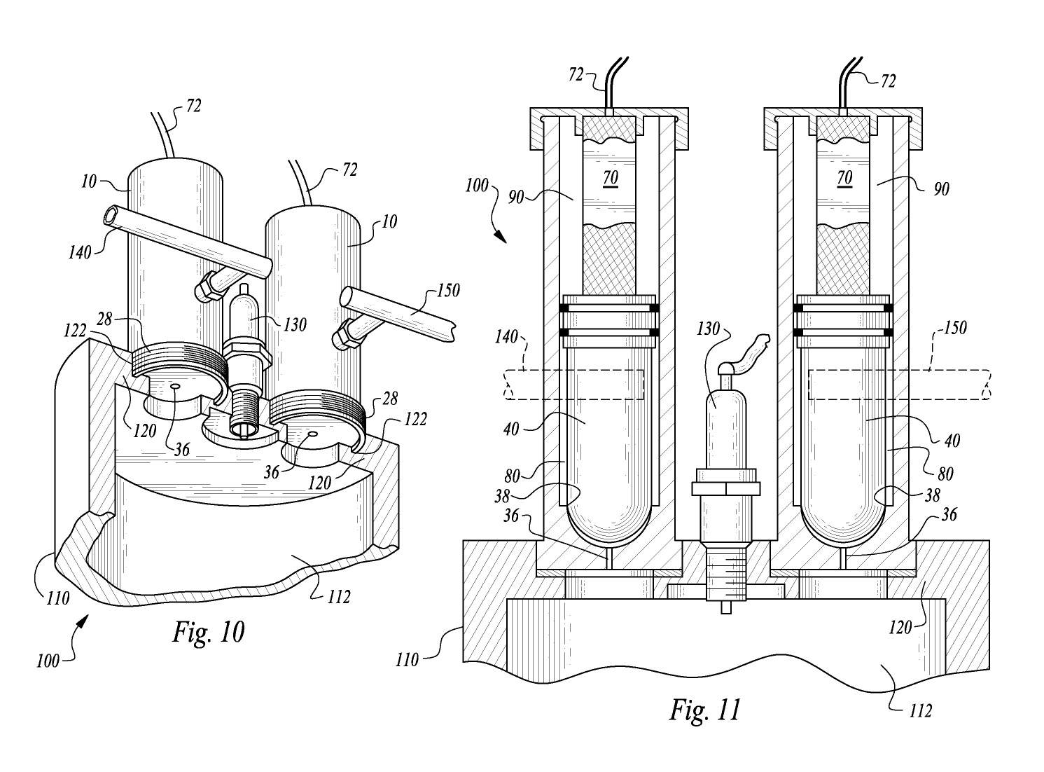

Referring now to FIG. 10, a cutaway perspective cross-section of the upper portion of the pulse detonation engine 100 is shown. The injectors 10 engage the injection end 120 of the tube 110 of the pulse detonation engine 100 at threaded locations 122. Although shown engaged via threaded means, the injectors 10 can be attached using other attachment means, including a bolted flange, a welded element or other similar attachment means. The injectors 10 attach to the injection end 120 of the detonation tube 110 of the pulse detonation engine 100.

FIG. 11 shows a cross section of both the pulse detonation engine 100 and the injectors 10. Each injector 10 incorporates a piezoelectric stack 70 for driving and translating the flow control member 40 to control the flow of fuel. Cables 72 deliver power to the stack 70 and release power from the stack 70. An outlet nozzle 36 comprises an orifice that can both limit the maximum flow and determine the spray pattern of out the injector 10 and into the combustion chamber 112 of the pulse detonation engine 100. The shoulder 38 forms a seal with the flow control member 40 to interrupt flow. The piezoelectric stack 70 resides in an upper portion 90 of the injector 10. Fuel flows through a lower portion 80 of the injector 10. The igniter 130 resides between the two injectors 10 such that the igniter ignites fuel from either injector 10.

Now, in additional detail, several embodiments and aspects of the pulse detonation engine 100 can be implemented, as follows. A pulse detonation engine 100 comprises a detonation tube 110 having an injection end 120 and an opposing thrust end 124, and one or more injection ports 122, the injection ports 122 penetrating the injection end 120 and communicating with a combustion chamber 112 of the detonation tube 110. One or more igniters 130 are deployed within the injection end 120 and positioned to supply electrical spark into the combustion chamber 112 adjacent the injection ports 122 to provide ignition of fuel/oxidizer mixtures. Fuel injectors 10 are inserted in the injection ports 122, each fuel injector 10 having an injector housing 20 which includes an inner chamber 30 with an inner nozzle surface 34 providing egress from the inner chamber 30. An inlet nozzle 22 is attached to the injector housing 20, providing ingress into the inner chamber 30. A supply line 140, 150 connects to the inlet nozzle 22 to supply fuel and oxidizer to the fuel injector 10. A flow control member 40 is disposed within the inner chamber 30 to control flow of fuel through the inner nozzle surface 34. The flow control member 40 has a nose 48 and a seal 44 circumscribing the flow control member 40, used to create a pressure seal within the inner chamber 30 to isolate an upper portion 90 of the inner chamber 30 from a lower portion 80 of the inner chamber. A shoulder 38 circumscribes the inner nozzle surface 34, and includes a sealing edge 39; the nose 48 of the flow control member 40 engages the sealing edge 39 to interrupt flow through the fuel injector 10. The nose 48 of the flow control member 40 is retracted away from the sealing edge 39 by the piezoelectric stack 70 to provide flow through the injector 10 and into the combustion chamber 112 of the detonation tube 110. The piezoelectric stack 70 is joined to the flow control member 40, and directly drives the flow control member 40. A control system comprising drive electronics connected to the piezoelectric stack 70 is configured to control movement of the flow control member 40 within the inner chamber 30.

In additional aspects, the pulse detonation engine 100 includes a deformable sealing edge 39 within the injector 10, conforming to the nose 48 of the flow control member 40. Additionally, the drive electronics further comprise a power amplifier, power filters, and a processor providing custom design of a driving waveform; and, a user interface providing user control of the driving waveform via pre-programmed behavior. The drive electronics continuously control the displacement, d, of the flow control member 40 to one or more intermediate displacement positions as well as a fully open position and a fully closed position.

In other aspects, the pulse detonation engine 100 is adaptable to various operational requirements via the use of the fuel injector 10 wherein the fuel injector 10 includes a nose 48 whose shape is variable, selectable and interchangeable, thereby allowing a designer to select a desired shape to deliver a desired fuel flow profile and a desired fuel flow spray pattern specific to a mission and operational profile of the pulse detonation engine 100. Still further, the inner nozzle surface 34 of the fuel injector 10 incorporates an outlet nozzle 36 sized to limit flow of fuel into the combustion chamber 112 to an upper limit. The upper limit can be greater than the maximum rate capable of flowing through the annular flow area 37 of the injector 10, or less than the maximum capable rate, as preferred for operational considerations, including risk of malfunctioning injector 10.

In a further aspect, the piezoelectric stack 70 of the injector 10 of the pulse detonation engine 100 drives the flow control member through a plurality of intermediate displacement positions creating a corresponding annular flow area 37 for each of the intermediate displacement positions, where the corresponding annular flow area 37 is defined by the sealing edge 39 and the circumferential portion on the nose 48 of the flow control member 40 in closest proximity to the sealing edge 39 at each of the intermediate displacement positions. The annular flow area 37 is created between the nose 48 of the flow control member 40 and the inner nozzle surface 34 by displacement, d, of the flow control member 40 away from the inner nozzle surface 34 and is a function of the displacement, d, of the flow control member 40 within the injector housing 20. The diameter of the flow control member 40 is selected as a function of the available displacement, d, of the flow control member 40 within the injector housing 20 and the required annular flow area 37 necessary to accommodate a desired fuel flow rate into the combustion chamber 112 of the detonation tube. Where multiple injectors 10 are used to deliver fuel to a pulse detonation engine 400, reductions in size of each injector 10 can be achieved by distributing the fuel delivery requirement among all the injectors 10 available.

In another aspect, a pulse detonation engine 100 includes an injector valve 10 operable to allow or prevent the flow of fluid into a combustion chamber 112 of the pulse detonation engine 100. Although the valve 10 is typically used to deliver fuel for detonation, the valve 10 can also be configured to deliver an oxidizer, including air, into the combustion chamber 112.

Consequently, for a pulse detonation engine 100 having at least two valves 10, one can be dedicated to the delivery of fuel while the other is dedicated to the delivery of oxidizer. Thus, rather than depending on passive purging of the combustion chamber 112 of the detonation tube 110 which constrains the operational frequency and thrust associated with the pulse detonation engine 100, the injector 10 used to deliver oxidizer can be used to actively purge the combustion chamber 112 at a rate higher than that available passively. In one version, two end injectors 10 can be used to deliver oxidizer while injectors 10 deployed along the length of the detonation tube 110 deliver fuel for detonation. Of course, one would recognize that any of the valves 10 might be adapted for use that optimizes the engine performance in the context of operational requirements. For example, if a payload associated with the pulse detonation engine 100 is significant, the design can be adapted for maximum thrust rather than velocity.

The injector valve 10 comprises a cylindrical flow control member 40 linearly translatable within the housing 20 of the valve 10 and a circular sealing member 38, wherein an annular flow area 37 is defined therebetween for the flow of fluid therethrough. A valve moving member comprising a piezoelectric stack 70 moves the flow control member 40 axially between one or more positions. In a first position, the flow control member 40 is in sealing engagement with the circular shoulder 38 to close the annular flow area 37 to the flow of fluid therethrough. A plurality of additional intermediate positions are provided in which the flow control member 40 is positioned incrementally from the circular sealing member 38 and the annular flow area 37 is open to the flow of fluid therethrough. In a final position, the flow control member 40 is positioned a maximum distance from the circular sealing member 38 to establish a total displacement of the valve moving member and a maximum annular flow area 37 for the valve 10. The valve moving member can be comprised of a plurality of piezoelectric stacks 70. For example, in one version, the valve moving member further comprises at least two piezoelectric stacks 70 positioned mechanically in series, wherein the total displacement, d, is a sum of the individual displacements, d, for all stacks. Additionally, one or more of the piezoelectric stacks 70 is energized to apply force in opposition to force exerted by a remainder of the piezoelectric stacks 70.

### Thrust Arrays

In another aspect, a thrust array comprises two or more pulse detonation engines 100 having one or more fuel injectors 10, said fuel injectors 10 disposed in an injector end 120 of a detonation tube 110 of the pulse detonation engine 100, an inlet nozzle 22 of each of the fuel injectors 10 connected to a fuel supply line 250; and an igniter 130 disposed in the injector end 120 of the detonation tube 110.

### Linear Thrust Array

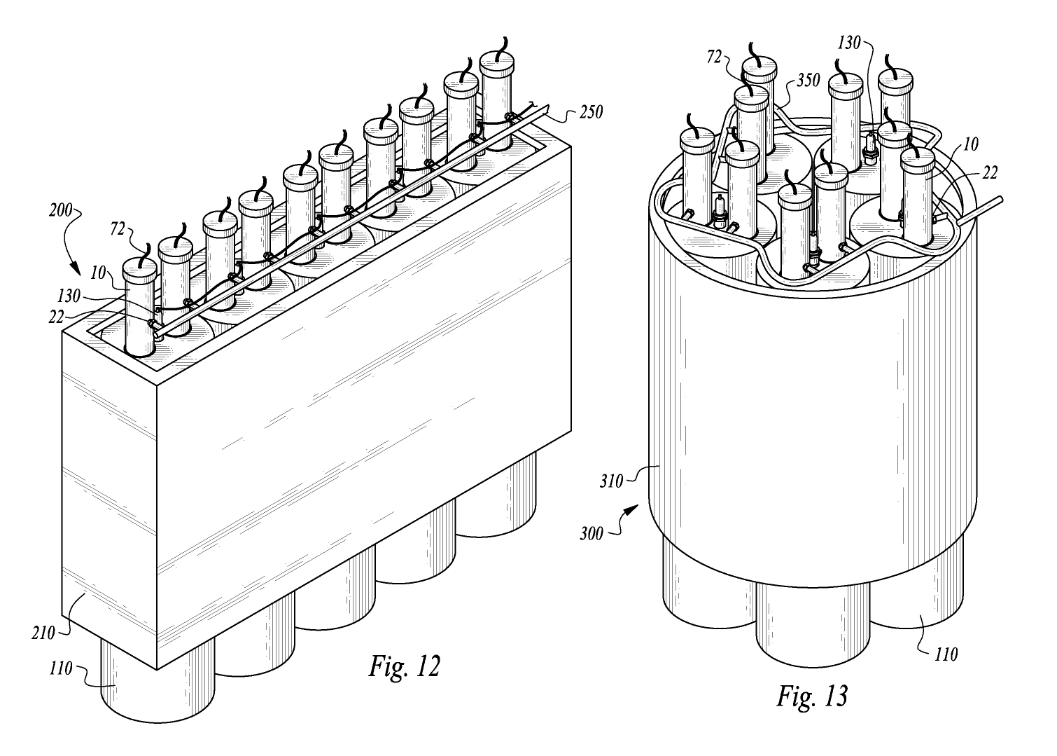

In one version, referring to FIG. 12, a linear thrust array 200 comprises multiple pulse detonation engines 100 arranged within a linear enclosure 210, causing said pulse detonation engines 100 to be linearly aligned. FIG. 12 shows a perspective view of a pulse detonation engine linear thrust array 200 comprised of five single tube pulse detonation engines 100 enclosed in a rectangular linear enclosure 210. Each injector 10 connects to a supply line 250 through which fuel is delivered to each injector 10 at a common pressure. Fuel can also be delivered independently via separate supply lines to one or more injectors 10. Multiple igniters 130 are wired in parallel to a common bus integrated with the control system such that each igniter 130 associated with each pulse detonation engine 100 can be triggered as desired to accommodate the desired thrust and timing to accommodate the flight characteristics of an aircraft or other airborne vehicle wherein the linear array 200 is integrated with the vehicle to provide thrust. Configured in a linear manner, the linear array 200 is more easily mounted on a wing of an airborne vehicle.

### Cylindrical Thrust Array

FIG. 13 shows a perspective view of a, cylindrical thrust array 300 comprised of five single tube pulse detonation engines 100 enclosed in a cylindrical enclosure 310. A fuel supply line 350 delivers fuel to each of the single tube pulse detonation engines 100. Thus configured, the control system of the cylindrical pulse detonation engine array 300 is able to provide directional thrust by timing the output of each individual pulse detonation engine 100. Where only three pulse detonation engines are used, a triangular pattern is created which still provides directional thrust in support of fluidic vectoring. In other versions, one or more pulse detonation engines can be positioned concentrically within the array of other pulse detonation engines. Thus configured, the cylindrical array 300 lends itself to use in rockets, missiles and jets.

### Multi-injector Pulse Detonation Engine

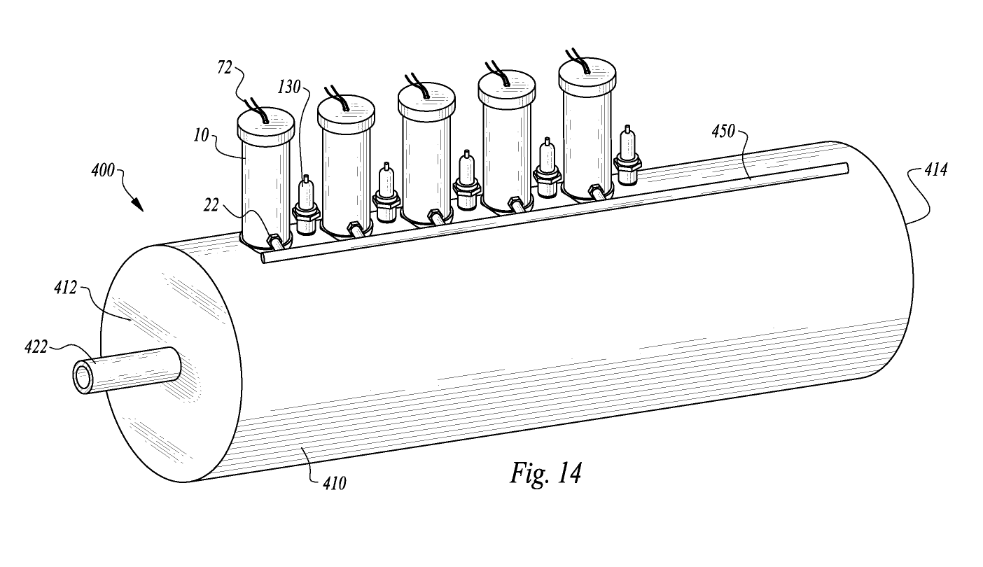

FIG. 14 is a perspective view of an alternative embodiment according to the present invention. Although shown in FIG. 12 and FIG. 13 as having two injectors 10 disposed in the injection end 120 of each detonation tube 110, another aspect shown in FIG. 14 comprises a pulse detonation engine 400 having one or more injectors 10 disposed along the length of a single detonation tube 410. The pulse detonation engine 400 is configured to have an array of injectors 10 along the length of the detonation tube 410. Thus configured, each of the injectors 10 can be controlled and modulated to deliver different rates of fuel flow along the length of the inner combustion chamber 412. In addition, each of the injectors 10 can be modulated to deliver fuel at different times during each detonation cycle. In addition, each of the injectors 10 can have a different type of fuel supplied to the injector 10 for injection at optimal times during the detonation cycle, thus allowing the use of multiple fuels simultaneously. In this manner, the fuel-air mixture can be optimized for a specific geometric configuration of the detonation tube 410 and inner combustion chamber 412.

With reference to FIG. 14, in a further version, the pulse detonation engine 400 includes two or more fuel injectors 10 disposed along the length of the detonation tube 410 of the pulse detonation engine 400, thereby supporting injection of one or more fuel types at different, locations, times and rates within the inner combustion chamber 412 of the pulse detonation engines 400. A common fuel supply line 450 provides fuel to each of the injectors 10. In other versions, separate fuel supply lines can be routed to deliver different fuel to each of the injectors 10. Each injector 10 includes conductors 72 for delivering and receiving electrical current from the piezoelectric stack 70 within the injector 10. An inlet 422 of the detonation tube 412 is provided for provisioning air or other oxidizer to the inner combustion chamber 412 of the pulse detonation engine 400. Air or oxidizer can be delivered through the inlet 422 by means of pump or compressor, as appropriate to the state and type of oxidizer used by the pulse detonation engine 400.

The nature of the fuel injectors 10 allows the fuel:air mixture within the inner combustion chamber 412 of the detonation tube 410 to be controlled in an analogue manner. However, there is a delay in time between when fuel is injected, and when that injected fuel reaches any specific location within the inner combustion chamber 412 of the tube 410. This time delay will depend upon a number of factors such as length and geometry of the inner combustion chamber 412 and tube 410, velocity of airflow through the inner combustion chamber 412 and tube 410, and characteristics of the injector 10 itself. Delays between cause and action within any closed loop feedback system cause either instability or greater complexity in a control system. By placing multiple injectors 10 at locations along the tube 410, this time delay can be reduced, and allow for greater control of the variation of the fuel:air mixture within the inner chamber 412 of the detonation tube 410. As part of a closed loop feedback system, the multiple fuel injectors 10 will allow for improved control of behavior of the system both within and between detonation cycles.

As flow within the inner chamber 412 of the tube 410 is not always smooth or laminar and is disrupted by the presence of objects such as an igniter 430, environmental conditions, movement of the entire pulse detonation engine 400, and, acceleration of the pulse detonation engine 400 in transit, the ability to more precisely control the fuel delivery within the tube 410 will allow for refinement of performance that would not be possible with a single injector 10, or where all injectors 10 are upstream from the disrupting influence.

Computational fluid dynamics simulations, flow experiments, and device testing determine the optimal fuel:air mixture distribution at any time or location within the detonation tube 410 and allow for optimum number, design, location, orientation, placement, and time varying behavior of the fuel injectors 10.

Additionally, although FIG. 14 depicts the injectors 10 and igniters 130 as being linearly disposed along the length of the detonation tube 410, other configurations are available to address various operational requirements. First, means for ignition can be incorporated within the interior of the detonation tube 410, hence, the externally fitted igniters 130 would not be required. Second, the injectors 10 can be disposed about the detonation tube 410 in multiple patterns. Although shown herein as disposed linearly, the injectors 10 can be disposed radially about the detonation tube creating a concentric array of injectors 10. Thus configured, the pulse detonation engine 400 provides a configuration suitable to powering a turbine, where the turbine is mounted on appropriate shafts within the detonation tube 410 of the pulse detonation engine 400. Additionally, the injectors 10 can be disposed in a spiral manner along the length of the detonation tube 410. Thus configured, a different turbine structure can be used. In either case, the combination of the pulse detonation engine 400 with the turbine configuration will provide a significantly more efficient system due to the use of detonation rather than combustion to power the turbine. Further, any combination of linear, radial and spiral injector deployment can be used to provide a desired injection profile. Still further, in combination with both simulation and empirical testing, the injectors 10 can be randomly disposed along the length of the detonation tube 410 to provide injection at locations indicated by the simulation and empirical testing to enhance the laminar or other flow characteristics of the pulse detonation engine 400. Even further, each of the injectors 10 can be oriented at angles other than perpendicular to the detonation tube 410. This adaptable orientation provides alternatives for direction of injection to offset motion of the pulse detonation engine 400 or to improve detonation characteristics of the pulse detonation engine 400 via enhanced mixing of the fuel:air mixture.

The reader's attention is directed to all papers and documents which are open to public inspection with this specification, and the contents of all such papers and documents are incorporated herein by reference. All the features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “steps for” performing a specific functions, is not to be interpreted as a “means” or “step” clause as specified in 35 U.S.C. Sec. 112, par. 6

### INDUSTRIAL APPLICABILITY

Embodiments of the present invention are applicable to a plurality of military and commercial propulsive systems and power generation devices including turbine generators. It is particularly applicable to applications using pulse detonation engines, where accurate, high frequency control with delivery of fuel at high rates and with a specific profile during each detonation cycle is desired. In its versions, embodiments, and aspects, the present invention is applicable to airborne or space-borne vehicles including rockets, missiles, jet engines, vehicle thrusters and other such applications.

We claim:

1. A pulse detonation engine, comprising:
(a) a detonation tube, said detonation tube having an injection end and an opposing thrust end, said detonation tube including one or more injection ports, said injection ports penetrating said injection end and communicating with a combustion chamber of said detonation tube;
(b) one or more igniters deployed within said injection end, said one or more igniters positioned to supply electrical spark into said combustion chamber adjacent said one or more injection ports to provide ignition of fuel/oxidizer mixtures;
(c) one or more fuel injectors, each of said one or more fuel injectors inserted in said one or more injection ports in said injection end of said detonation tube;
(d) each of said one or more fuel injectors having an injector housing,
(e) said injector housing having an inner chamber, said inner chamber having an inner nozzle surface providing egress from said inner chamber;
(f) an inlet nozzle attached to said injector housing and providing ingress into said inner chamber;
(g) a supply line connected to said inlet nozzle to supply fuel and oxidizer to said fuel injector;
(h) a flow control member seated within said inner chamber to control flow of fuel through said inner nozzle surface; said flow control member having a nose;
(i) a seal circumscribing said flow control member creating a pressure seal within said inner chamber to isolate an upper portion of said inner chamber from a lower portion of said inner chamber;
(j) a shoulder, said shoulder circumscribing said inner nozzle surface, said shoulder having a sealing edge, wherein said nose of said flow control member engages said sealing edge to interrupt flow through said fuel injector, and, said nose of said flow control member is retracted away from said sealing edge to provide flow through said flow control member and into said combustion chamber of said detonation tube;
(k) a piezoelectric stack joined to said flow control member, said flow control member driven directly by said piezoelectric stack; and
(l) drive electronics connected to said piezoelectric stack, said drive electronics configured to control movement of said flow control member within said inner chamber.

2. The pulse detonation engine as recited in claim 1, wherein said sealing edge is deformable, conforming to a nose of said flow control member.

3. The pulse detonation engine as recited in claim 1, said drive electronics further comprising:
(a) a power amplifier, power filters, and a processor providing custom design of a driving waveform;
(b) a user interface providing user control of said driving waveform via pre-programmed behavior;
(c) said flow control member driven continuously by said drive electronics to one or more intermediate displacement positions;
(d) said flow control member driven by said drive electronics in increments to one or more intermediate displacement positions; and
(e) said flow control member driven by said drive electronics to a fully open position and a fully closed position.

4. The pulse detonation engine as recited in claim 3, wherein a shape of said nose of said flow control member being variable, selectable and interchangeable, thereby allowing a designer to select a desired shape to deliver a desired fuel flow profile and a desired fuel flow spray pattern specific to a mission and operational profile of said pulse detonation engine.

5. The pulse detonation engine as recited in claim 1, wherein said inner nozzle surface further comprises an outlet nozzle sized to limit flow of fuel into said combustion chamber to an upper limit.

6. The pulse detonation engine as recited in claim 1, wherein one or more fuel injectors are disposed along the length of said detonation tube, thereby supporting injection of one or more fuel types at different locations, at different times and at different rates within said combustion chamber of said pulse detonation engine.

7. The pulse detonation engine as recited in claim 1, wherein said piezoelectric stack drives said flow control member through a plurality of intermediate displacement positions creating a corresponding annular flow area for each of said plurality of intermediate displacement positions, each said corresponding annular flow area defined by said sealing edge and a location on a nose of said flow control member in closest proximity to said sealing edge at said each of said plurality of intermediate displacement positions.

8. The pulse detonation engine as recited in claim 7, wherein an annular flow area is created between said nose of said flow control member and said inner nozzle surface by a displacement of said flow control member away from said inner nozzle surface wherein said annular flow area is a function of said displacement of said flow control member within said injector housing.

9. The pulse detonation engine as recited in claim 8, wherein a diameter of said flow control member is selected as a function of said displacement of said flow control member within said injector housing and said annular flow area to accommodate a desired fuel flow rate into said combustion chamber of said detonation tube.

10. A pulse detonation engine including a valve operable to allow or prevent the flow of fluid to or from a combustion chamber of said pulse detonation engine, said valve comprising:
(a) a cylindrical flow control member linearly translatable within a body of said valve and a circular sealing member, said cylindrical flow control member and said circular sealing member defining an annular flow area therebetween for the flow of fluid therethrough; and
(b) a valve moving member for moving said flow control member axially between one or more positions, a first position in which said flow control member is in sealing engagement with said circular sealing member to close said annular flow area to the flow of fluid therethrough, a plurality of additional intermediate positions in which said flow control member is positioned incrementally from said circular sealing member and said annular flow area is open to the flow of fluid therethrough, and a final position in which said flow control member is positioned a maximum distance from said circular sealing member to establish a total displacement of said valve moving member and a maximum annular flow area for said valve.

11. The pulse detonation engine as recited in claim 10, wherein said valve moving member comprises a plurality of piezoelectric stacks.

12. The pulse detonation engine as recited in claim 11, wherein said valve moving member further comprises at least two piezoelectric stacks, said at least two piezoelectric stacks positioned mechanically in series, wherein said total displacement is a sum of individual displacements for said at least two piezoelectric stacks.

13. The pulse detonation engine as recited in claim 11, wherein at least one of said one or more piezoelectric stacks is energized to apply force in opposition to force exerted by a remainder of said one or more piezoelectric stacks.

14. The pulse detonation engine as recited in claim 10, a detonation tube of said pulse detonation engine configured to receive two or more valves positioned along said detonation tube, wherein each of said two or more valves are controlled independently to allow operation of each valve to occur at different times.

15. The pulse detonation engine as recited in claim 14 wherein said two or more valves are positioned in a ring about the perimeter of said detonation tube.

16. The pulse detonation engine as recited in claim 14 wherein said two or more valves are positioned in a spiral about the perimeter and length of said detonation tube.

17. The pulse detonation engine of claim 14 wherein said two or more valves are positioned at locations along and about said detonation tube to provide optimized operational performance.

18. The pulse detonation engine cited in claim 14 wherein each of said injectors is oriented non-perpendicularly to said detonation tube.

19. A thrust array comprising two or more pulse detonation engines comprised of one or more injectors, said injectors disposed in an injector end of a detonation tube of said pulse detonation engine, an inlet nozzle of each of said injectors connected to a supply line; and an igniter disposed in said injector end of said detonation tube.

20. The thrust array cited in claim 19, wherein said two or more pulse detonation engines are arranged linearly within a linear enclosure, said linear enclosure causing said pulse detonation engines to be aligned in a linear array.

21. The thrust array cited in claim 19, comprising at least three pulse detonation engines, wherein said at least three pulse detonation engines are arranged with a cylindrical enclosure, said cylindrical enclosure causing said at least three pulse detonation engines to be arranged in a triangular pattern, thereby supporting directional thrust.

22. The thrust array cited in claim 19, comprising at least five pulse detonation engines, wherein said at least five pulse detonation engines are arranged within said cylindrical enclosure in a circular pattern, thereby supporting directional thrust.

23. The thrust array cited in claim 22, wherein one of said at least five pulse detonation engines is mounted concentrically between a remainder of said at least five pulse detonation engines.
